(19) United States
(12) Patent Application Publication
(10) Pub. No.: US 2024/0253702 A1
(43) Pub. Date: Aug. 1, 2024

(54) UTILIZING AN ADJUSTABLE YOUTH FRAME WITHIN AN ADJUSTABLE YOUTH ELECTRIC OFF ROAD VEHICLE

(71) Applicant: Textron Inc., Providence, RI (US)

(72) Inventors: Trevor Douglas Roebuck, Evans, GA (US); Marcel Broennimann, Aiken, SC (US); Donny Hammond, Augusta, GA (US); Charles Dauchess, North Augusta, SC (US); Ricky Veldee Kemp, Augusta, GA (US)

(21) Appl. No.: 18/410,345

(22) Filed: Jan. 11, 2024

Related U.S. Application Data
(60) Provisional application No. 63/441,625, filed on Jan. 27, 2023.

(51) Int. Cl. B62D 21/14; B60K 1/04

(52) U.S. Cl. CPC B62D 21/14; B60K 1/04

(57) ABSTRACT

An adjustable youth electric off-road vehicle includes an adjustable youth frame constructed and arranged to adjust to a variety of different youth sizes. The adjustable youth electric off-road vehicle further includes a battery assembly supported by the adjustable youth frame, the battery assembly being constructed and arranged to store electric power. The adjustable youth electric off-road vehicle further includes an electric propulsion system supported by the adjustable youth frame. The electric propulsion system is electrically coupled with the battery assembly and is constructed and arranged to provide off-road vehicle propulsion using the electric power while the adjustable youth frame is adjusted to any of the different youth sizes. With such a vehicle, the adjustable youth frame may be adjusted over time to a variety of different youth sizes to accommodate a growing youthful rider.

### CROSS REFERENCE TO RELATED APPLICATIONS

This is a regular utility patent application of earlier-filed U.S. Application No. 63/441,625, filed on Jan. 27, 2023, and entitled “Utilizing an Adjustable Youth Frame within an Adjustable Youth Electric Off Road Vehicle”, the contents and teachings of which are hereby incorporated by reference in their entirety.

### BACKGROUND

A conventional all-terrain vehicle (ATV) includes a set of tires with aggressive treads, a rugged suspension, a straddle seat, handle bar steering, and a centrally located combustion engine. Such equipment enables a rider to maneuver the ATV over trails, rocky areas, muddy environments, and so on.

Before the rider acquires the ATV, the rider may test drive ATV models from different manufacturers to assess certain factors such as handling, comfort, fit, balance, etc. Often the rider chooses the ATV model that provides an optimum combination of such factors.

### SUMMARY

Unfortunately, for a youthful rider, the factors that the rider used when choosing an ATV model change as the rider matures. For example, the youthful rider may grow, and later find that the distance(s) between the straddle seat relative to the foot rests and/or the handle bars is(are) no longer comfortable. As another example, the rider may gain weight, and discover that the ATV is no longer balanced or determine that the ATV no longer handles the same way due to the change in weight distribution. Moreover, the rider may anticipate that the ATV model that fits well today will no longer fit in a year or two, and acquire an ATV that is currently too large or perhaps even defer getting an ATV altogether.

Improved techniques are directed to utilizing an adjustable youth frame within an adjustable youth electric off-road vehicle. Such techniques may enable the frame to adjust to a variety of different youth sizes to accommodate rider changes over time. Along these lines, the vehicle may include an adjustable swing arm assembly for setting different vehicle heights, different foot-rest settings for controlling the distance between the seat and the foot-rests, a modular and/or adjustable handlebar to change the distance between the seat and certain handlebar controls, combinations thereof, and so on. Moreover, the placement and/or configuration of various electric components such as the battery, the electric motor, the motor controller, etc. on such a frame enable the adjustable youth electric off-road vehicle to be easily constructed, to be adjusted to accommodate rider changes, and/or to be conveniently serviced over time.

One embodiment is directed to an adjustable youth electric off-road vehicle which includes an adjustable youth frame constructed and arranged to adjust to a variety of different youth sizes. The adjustable youth electric off-road vehicle further includes a battery assembly supported by the adjustable youth frame, the battery assembly being constructed and arranged to store electric power. The adjustable youth electric off-road vehicle further includes an electric propulsion system supported by the adjustable youth frame. The electric propulsion system is electrically coupled with the battery assembly and is constructed and arranged to provide off-road vehicle propulsion using the electric power while the adjustable youth frame is adjusted to any of the different youth sizes.

Another embodiment is directed to an adjustable youth frame that adjusts to accommodate a variety of different electric off-road vehicle youth sizes. The adjustable youth frame includes a front lower sub-frame that defines a front of an adjustable youth electric off-road vehicle and that is constructed and arranged to support a battery assembly that stores electric power. The adjustable youth frame further includes an upper rear sub-frame that couples with the front lower sub-frame, the upper rear sub-frame defining a rear of the adjustable youth electric off-road vehicle. The adjustable youth frame further includes an adjustable swing arm assembly that couples with the upper rear sub-frame. The adjustable swing arm assembly is constructed and arranged to support at least a portion of an electric propulsion system that electrically couples with the battery assembly to provide off-road vehicle propulsion using the electric power while the adjustable youth frame is adjusted to any of the different electric off-road vehicle youth sizes.

Yet another embodiment is directed to a method of providing an adjustable youth electric off-road vehicle. The method includes attaching a battery assembly to a lower sub-frame that defines a front of the adjustable youth electric off-road vehicle. The battery assembly is constructed and arranged to store electric power. The method further includes, after the battery assembly is attached to the lower sub-frame, coupling an upper sub-frame with the lower sub-frame, the upper sub-frame defining a rear of the adjustable youth electric off-road vehicle. The method further includes pivotally coupling an adjustable swing arm assembly that supports an electric motor to the upper sub-frame. The electric motor is constructed and arranged to provide off-road vehicle propulsion using the electric power. The lower sub-frame, the upper sub-frame and the adjustable swing arm assembly form an adjustable youth frame which is configured to adjust to a variety of different youth sizes.

Other embodiments are directed to higher and lower level systems, sub-systems, assemblies, apparatus, and so on. Some embodiments are directed to various processes, components, and mechanisms which are involved in utilizing an adjustable youth frame within an adjustable youth electric off road vehicle.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same or similar parts throughout the different views. The drawings are not necessarily to scale, emphasis instead being placed upon illustrating the principles of various embodiments of the present disclosure.

FIG. 1 is a side view of an adjustable youth electric off-road vehicle in accordance with certain embodiments.

FIG. 2 is a front view of the adjustable youth electric off-road vehicle in accordance with certain embodiments.

FIG. 3 is a top view of the adjustable youth electric off-road vehicle in accordance with certain embodiments.

FIG. 4 is a rear view of the adjustable youth electric off-road vehicle in accordance with certain embodiments.

FIG. 5 is a bottom view of the adjustable youth electric off-road vehicle in accordance with certain embodiments.

FIG. 6 is a reverse angle perspective view of an adjustable youth frame in accordance with certain embodiments.

FIG. 7 is a side view of the adjustable youth frame in accordance with certain embodiments.

FIG. 8 is a front view of the adjustable youth frame in accordance with certain embodiments.

FIG. 9 is a top view of the adjustable youth frame in accordance with certain embodiments.

FIG. 10 is a perspective view of a front lower sub-frame in accordance with certain embodiments.

FIG. 11 is a reverse angle perspective view of the front lower sub-frame in accordance with certain embodiments.

FIG. 12 is a side view of the front lower sub-frame in accordance with certain embodiments.

FIG. 13 is a front view of the front lower sub-frame in accordance with certain embodiments.

FIG. 14 is a top view of the front lower sub-frame in accordance with certain embodiments.

FIG. 15 is a bottom view of the front lower sub-frame in accordance with certain embodiments.

FIG. 16 is a perspective view of an upper rear sub-frame in accordance with certain embodiments.

FIG. 17 is a side view of the upper rear sub-frame in accordance with certain embodiments.

FIG. 18 is a front view of the upper rear sub-frame in accordance with certain embodiments.

FIG. 19 is a top view of the upper rear sub-frame in accordance with certain embodiments.

FIG. 20 is a bottom view of the upper rear sub-frame in accordance with certain embodiments.

FIG. 21 is a bottom view of an adjustable youth electric off-road vehicle without tires in accordance with certain embodiments.

FIG. 22 is a bottom view of the adjustable youth electric off-road vehicle with tires in accordance with certain embodiments.

FIG. 23 is a rear view showing a swing arm assembly in accordance with certain embodiments.

FIG. 24 is rear perspective view of a portion of the swing arm assembly in accordance with certain embodiments.

FIG. 25 is side view of another portion of the swing arm assembly in accordance with certain embodiments.

FIG. 26 is a perspective view of yet another portion of the swing arm assembly in accordance with certain embodiments.

FIG. 27 is a perspective view of an upper rear sub-frame which is constructed and arranged to couple with the swing arm assembly in accordance with certain embodiments.

FIG. 28 is a rear view of a first swing arm arrangement in accordance with certain embodiments.

FIG. 29 is a rear perspective view of the first swing arm arrangement in accordance with certain embodiments.

FIG. 30 is a side view of the first swing arm arrangement in accordance with certain embodiments.

FIG. 31 is another rear perspective view of the first swing arm arrangement in accordance with certain embodiments.

FIG. 32 is another side view of the first swing arm arrangement in accordance with certain embodiments.

FIG. 33 is yet another rear perspective view of the first swing arm arrangement in accordance with certain embodiments.

FIG. 34 is a rear perspective view of a second swing arm arrangement in accordance with certain embodiments.

FIG. 35 is another rear/underneath perspective view of the second swing arm arrangement in accordance with certain embodiments.

FIG. 36 is a side view of the second swing arm arrangement in accordance with certain embodiments.

FIG. 37 is a rear perspective view of a third swing arm arrangement in accordance with certain embodiments.

FIG. 38 is another rear perspective view of the third swing arm arrangement in accordance with certain embodiments.

FIG. 39 is a rear perspective view of at least a portion of the third swing arm arrangement in accordance with certain embodiments.

FIG. 40 is a rear perspective view of an alternative a portion of the third swing arm arrangement in accordance with certain embodiments.

FIG. 41 is a view of an adjustable foot rest feature which is provided by an adjustable youth electric off-road vehicle in accordance with certain embodiments.

FIG. 42 is a view of a contactor in accordance with certain embodiments.

FIG. 43 shows a method of providing an adjustable youth electric off-road vehicle in accordance with certain embodiments.

### DETAILED DESCRIPTION

An improved technique is directed to utilizing an adjustable youth frame within an adjustable youth electric off-road vehicle. Such a technique may enable the adjustable youth frame to adjust to a variety of different youth sizes to accommodate rider changes over time. Along these lines, the vehicle may include an adjustable swing arm assembly for setting different vehicle heights, different foot-rest settings for controlling the distance between the seat and the foot-rests, and a modular and/or adjustable handlebar to change the distance between the seat and certain handlebar controls, among other things. Moreover, the placement and/or configuration of various electric propulsion components such as a battery, an electric motor, a motor controller, etc. on such a frame enable such an adjustable youth electric off-road vehicle to be easily constructed, adjusted for rider changes, and/or serviced over time.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

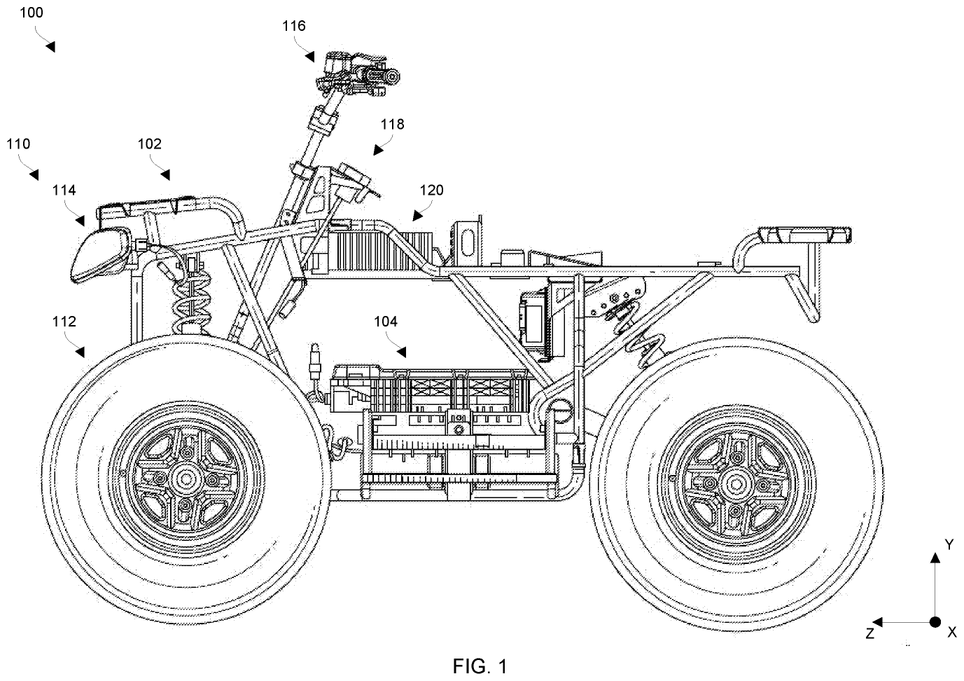

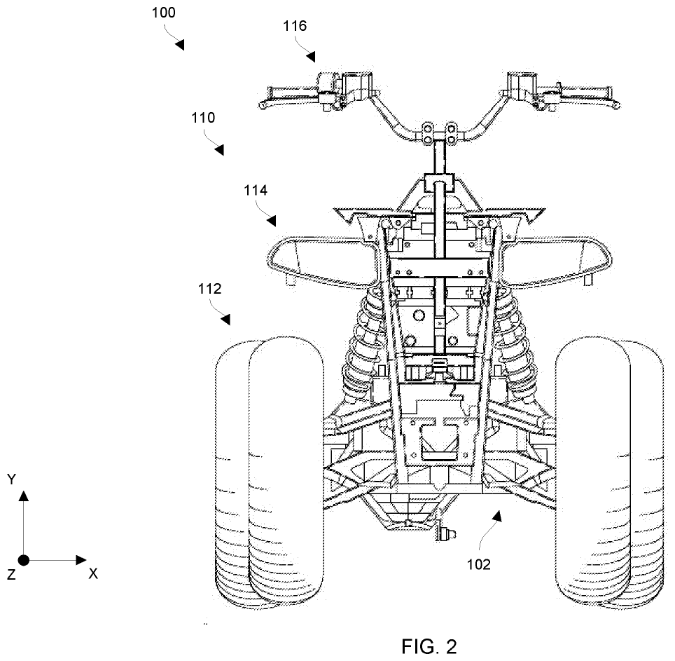

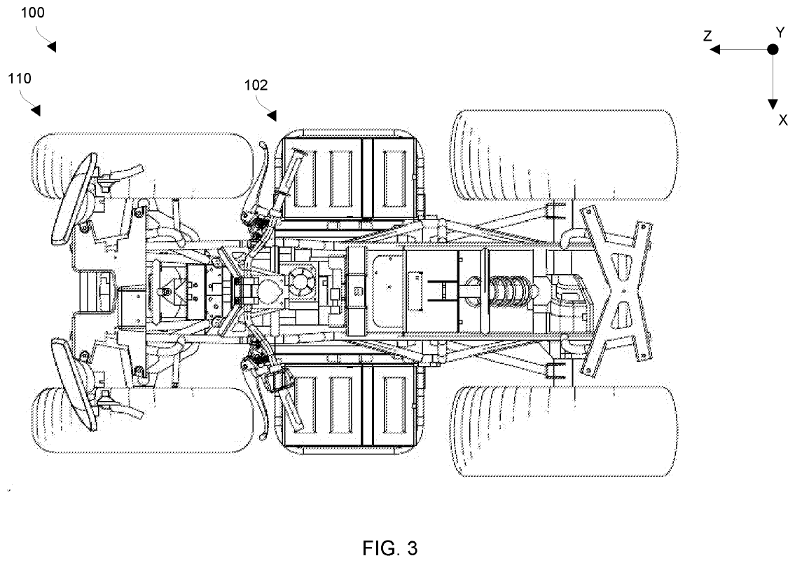

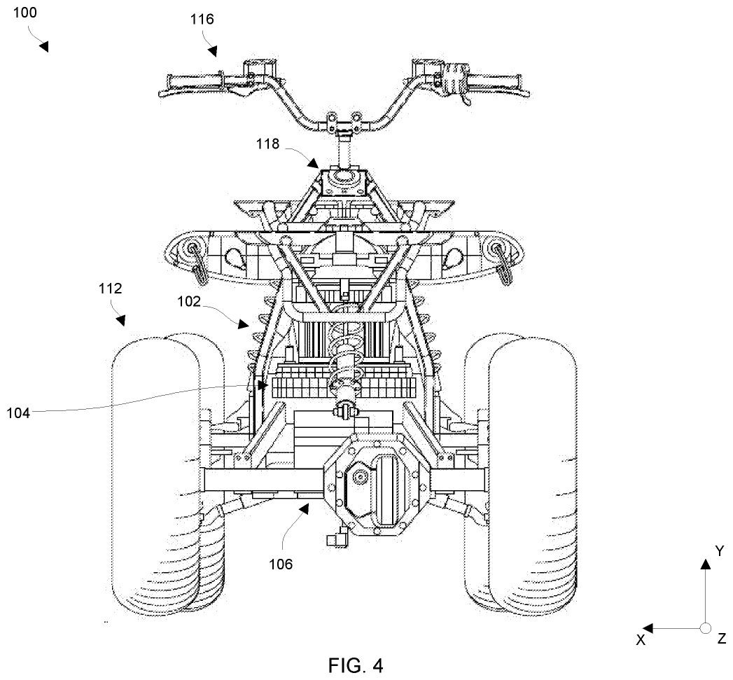

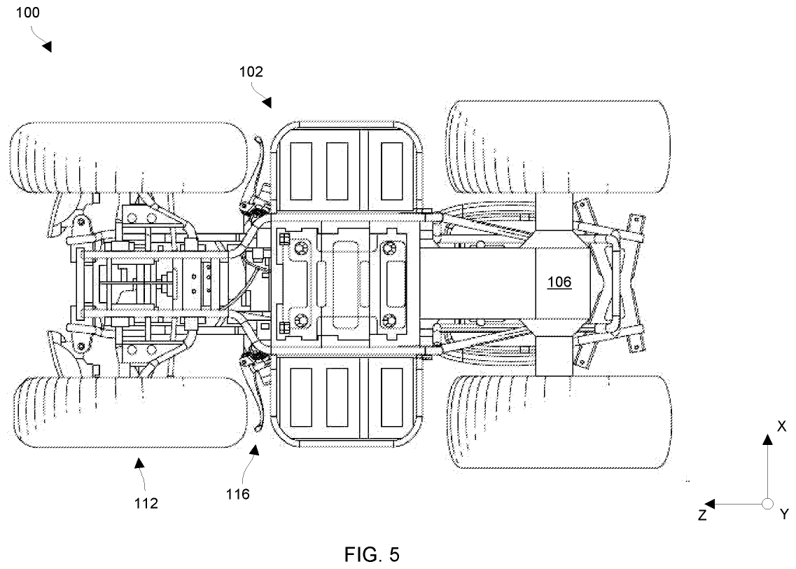

FIGS. 1-5 show an adjustable youth electric off-road vehicle 100 which is capable of accommodating a variety of different youth sizes in accordance with certain embodiments. FIG. 1 is a side view of the adjustable youth electric off-road vehicle 100. FIG. 2 is a front view of the adjustable youth electric off-road vehicle 100. FIG. 3 is a top view of the adjustable youth electric off-road vehicle 100. FIG. 4 is a rear view of the adjustable youth electric off-road vehicle 100. FIG. 5 is a bottom view of the adjustable youth electric off-road vehicle 100 (i.e., a view from underneath).

As shown in FIGS. 1-5, the adjustable youth electric off-road vehicle 100 includes an adjustable youth frame 102, a battery assembly 104, and an electric propulsion system 106. It should be understood that certain components such as body panels, mud guards, a seat, and so on, may be included as part of the vehicle 100, but may have been omitted from view in one or more of the drawings.

The adjustable youth frame 102 is constructed and arranged to adjust to a variety of different youth sizes. Accordingly, various aspects of the adjustable youth electric off-road vehicle 100 may be modified to accommodate a growing/maturing youthful rider. Moreover, the adjustable youth electric off-road vehicle 100 may be customized to accommodate current features of a rider in the present (e.g., rider leg length, arm length, weight distribution, etc.).

The battery assembly 104 (e.g., see FIG. 1) is supported by the adjustable youth frame 102. The battery assembly 104 is constructed and arranged to store electric power. In some arrangements, the battery assembly 104 includes a set of lithium battery cells which recharge when a battery charger (e.g., onboard the vehicle 100, external to the vehicle 100, etc.) is connected to an external power source (e.g., street/wall power) to supply charge to the battery assembly 104.

The electric propulsion system 106 (e.g., see FIG. 4) is supported by the adjustable youth frame 102. The electric propulsion system 106 is electrically coupled with the battery assembly 104 and is constructed and arranged to provide off-road vehicle propulsion using electric power from the battery assembly 104 while the adjustable youth frame 102 is adjusted to any of the different youth sizes.

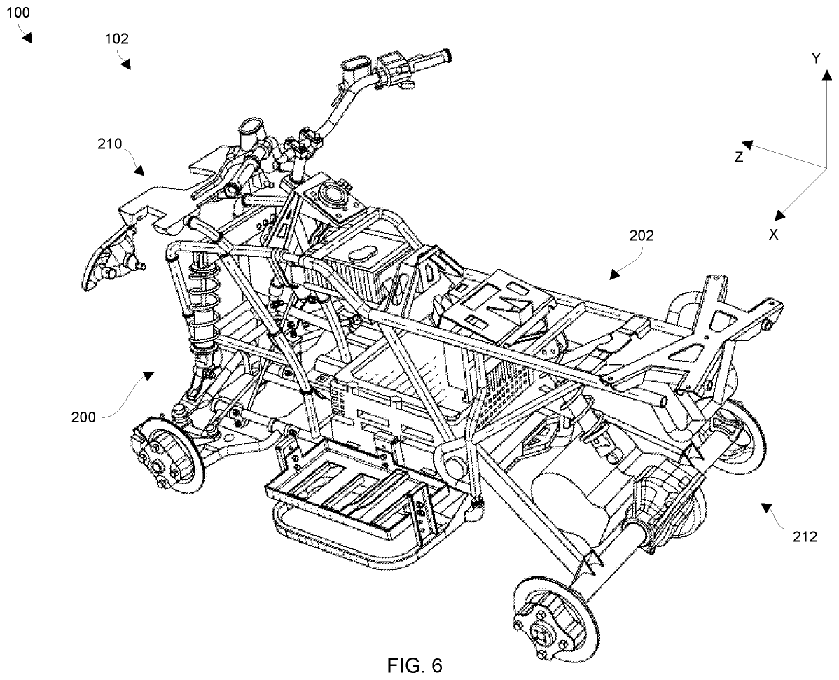

It should be appreciated that the adjustable youth electric off-road vehicle 100 includes other equipment 110 as well. For example, as best seen in FIG. 1, such other equipment 110 may include, among other things, tires 112, head lights 114, user controls 116, gauges/meters/display equipment 118, an onboard battery charger 120, and so on. Further details will now be provided with reference to FIGS. 6-20.

FIGS. 6-9 show certain details of the adjustable youth frame 102 in accordance with certain embodiments. Certain vehicle componentry may have been omitted from FIGS. 6-9 in order to show particular details.

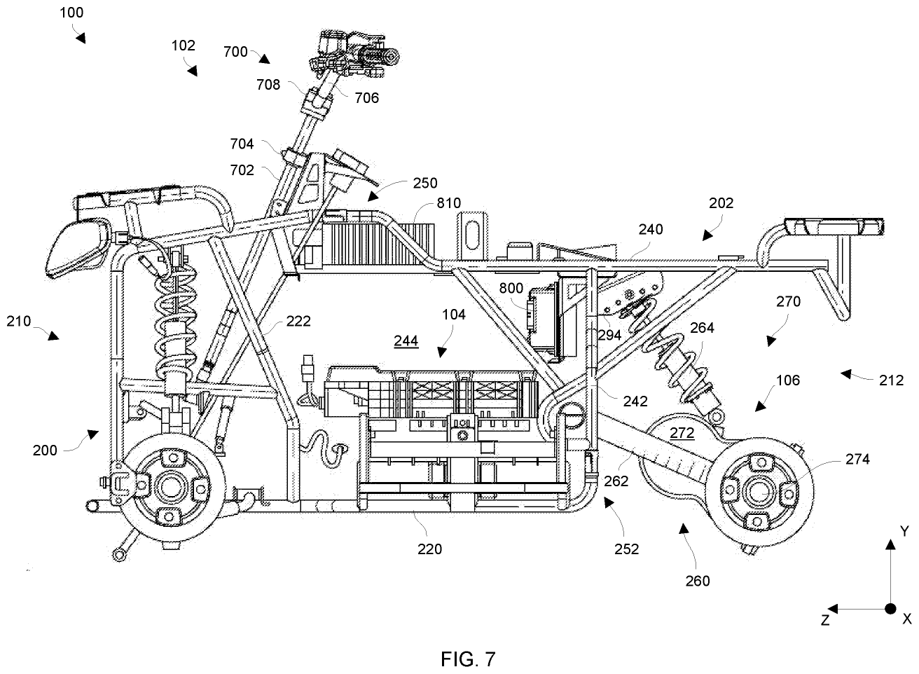

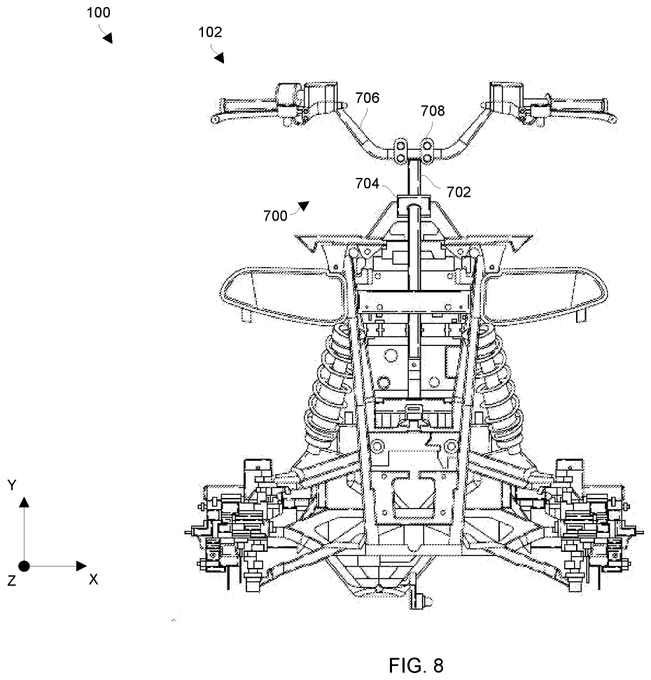

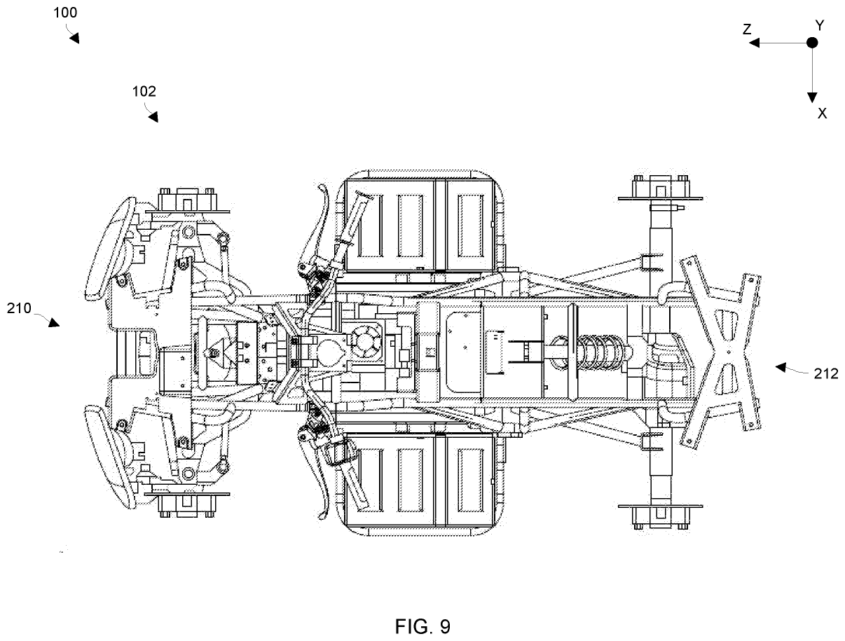

FIGS. 6-9 show the adjustable youth frame 102 in an assembled form in accordance with certain embodiments. FIG. 6 is a reverse angle perspective view. FIG. 7 is a side view. FIG. 8 is a front view. FIG. 9 is a top view.

As shown in FIGS. 6-9, the adjustable youth frame 102 includes a front lower sub-frame 200 and an upper rear sub-frame 202 which couples with the front lower sub-frame 200. The front lower sub-frame 200 defines a front 210 of the adjustable youth electric off-road vehicle 100 (i.e., a forward portion of the vehicle 100 that faces the positive Z-direction). Additionally, the upper rear sub-frame 202 defines a rear 212 of the adjustable youth electric off-road vehicle 100 (i.e., a rearward portion of the vehicle 100 that faces the negative Z-direction).

In accordance with certain embodiments, at least some of the front lower sub-frame 200 and the upper rear sub-frame 202 is made of one or more materials that provide high strength and resiliency such as metal (e.g., aluminum, steel, combinations thereof, etc.), carbon fiber, plastics, combinations thereof, and so on. Such materials may be solid, hollow, tubular, H-shaped in cross-section, combinations thereof, etc. Furthermore, the sub-frames 200, 202 and/or portions thereof may be fastened together via welds, hardware, epoxy/glues, combinations thereof, and so on.

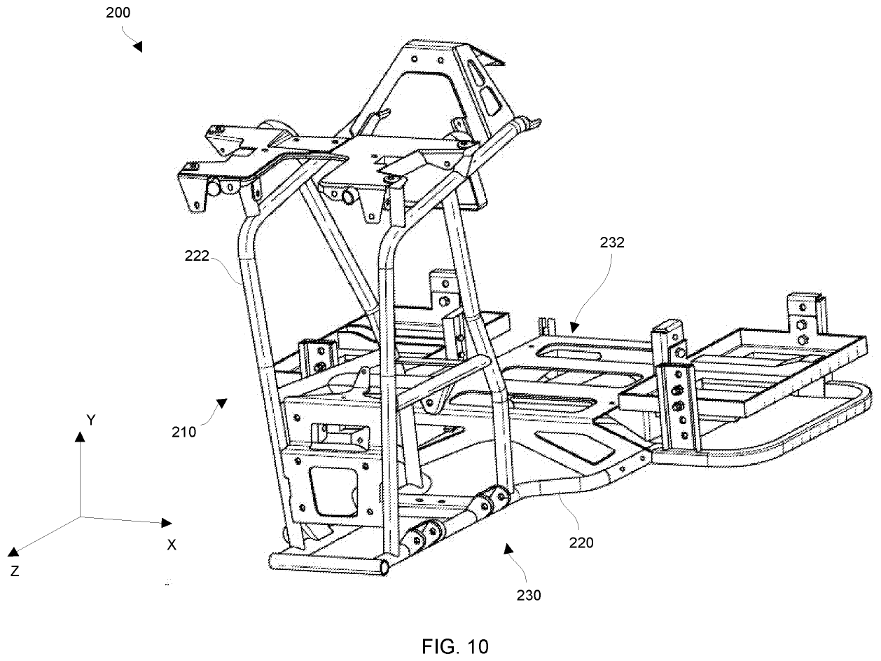

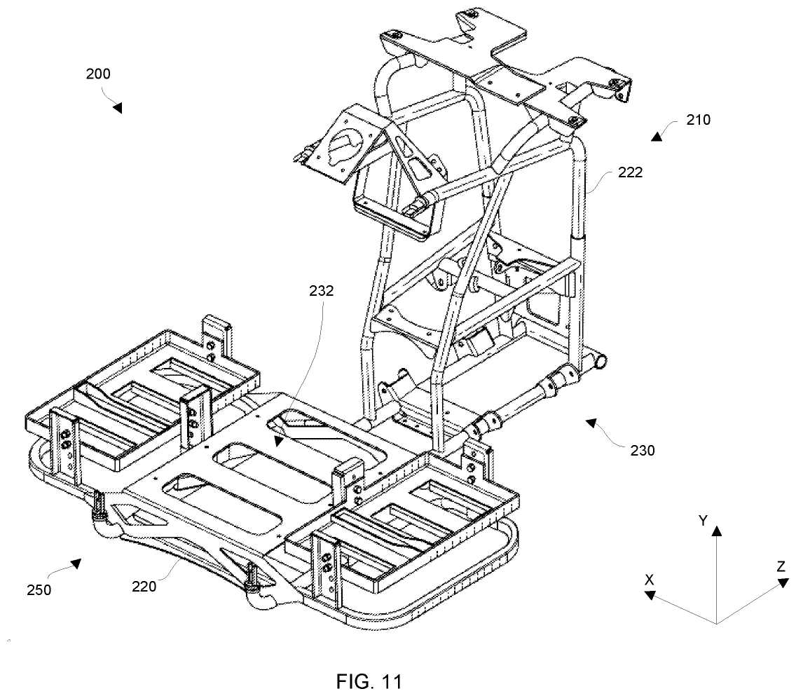

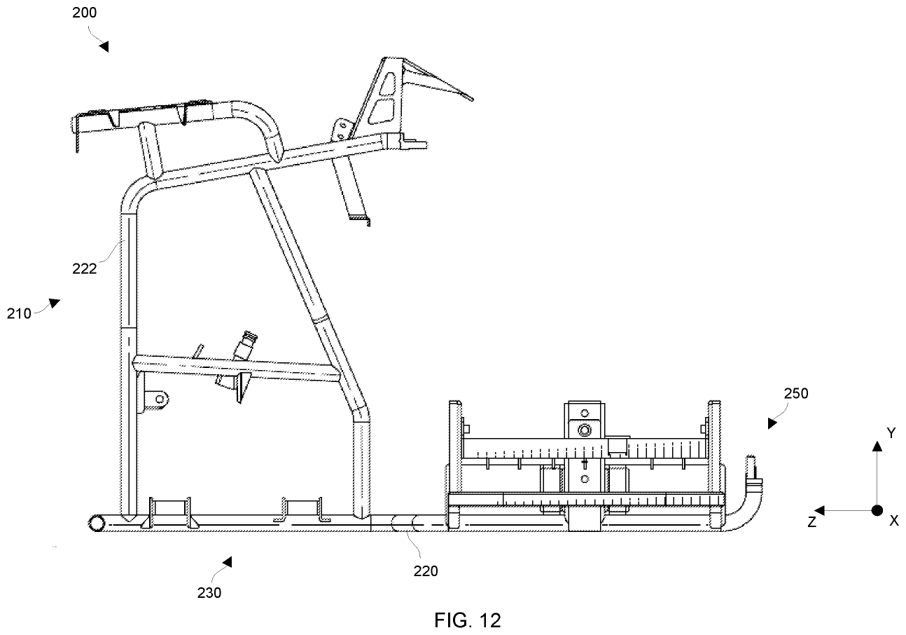

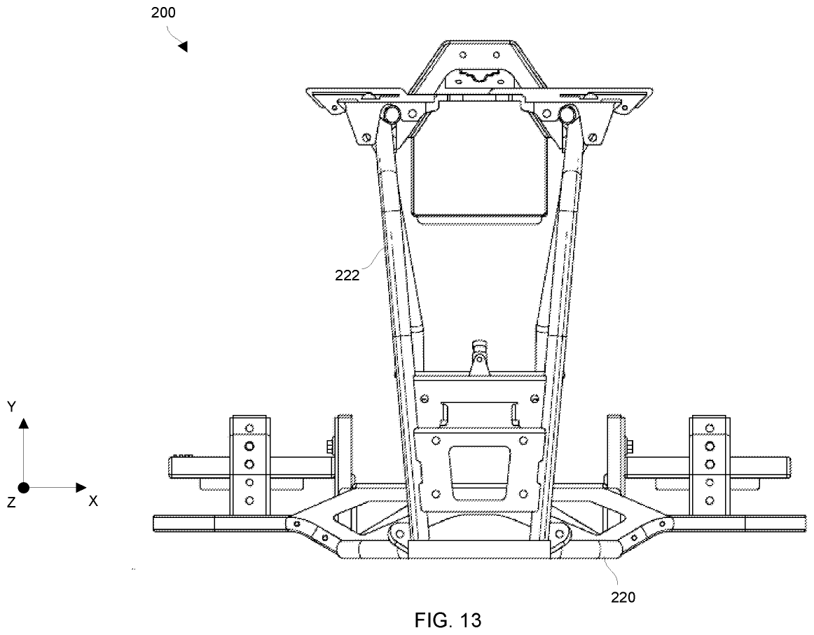

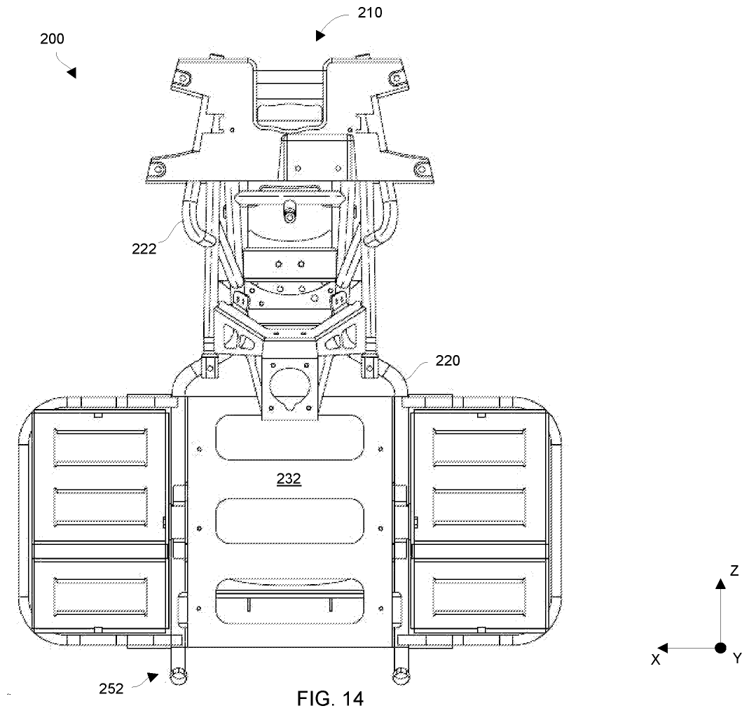

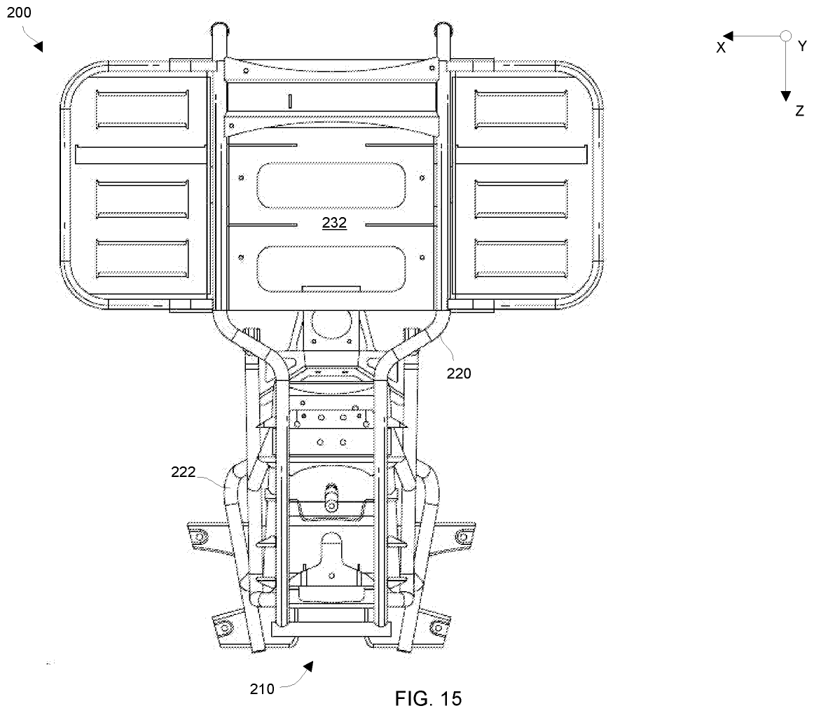

FIGS. 10-15 show further details of the front lower sub-frame 200 of the frame 102 in accordance with certain embodiments. FIG. 10 is a perspective view of the front lower sub-frame 200. FIG. 11 is a reverse angle perspective view of the front lower sub-frame 200. FIG. 12 is a side view of the front lower sub-frame 200. FIG. 13 is a front view of the front lower sub-frame 200. FIG. 14 is a top view of the front lower sub-frame 200. FIG. 15 is a bottom (or underneath) view of the front lower sub-frame 200.

As shown in FIGS. 10-15, the front lower sub-frame 200 includes a lower support 220 and a front section 222. The front section 222 extends upwardly in the Y-direction from a front region 230 of the lower support 220 (e.g., see FIGS. 10-12) to define the front 210 of the adjustable youth electric off-road vehicle 100.

In accordance with certain embodiments, the lower support 220 and a front section 222 provide various attachment locations for supporting and/or holding various vehicle componentry. Along these lines, the lower support 220 provides a central (or base) section 232 for supporting the battery assembly 104 (also see FIG. 1). With the battery assembly 104 supported by the central section 232 of the lower support 220, the vehicle 100 is able to provide a low center of gravity and uniform distribution of the weight of the battery assembly 104 for optimized vehicle handling and control when the vehicle 100 is in motion. As will be explained in further detail later, the lower support 220 provides support for other vehicle componentry such as foot rests (shown in FIGS. 10-15) and a front axle (shown in FIGS. 6-9).

In accordance with certain embodiments, the front section 222 of the front lower sub-frame 200 provides support for various vehicle componentry as well. Example vehicle componentry that is supported by the front section 222 include a set of body panels (omitted for simplicity) and various electrical equipment (e.g., see the head lights 114, user controls 116, gauges/meters/display equipment 118 in FIG. 1).

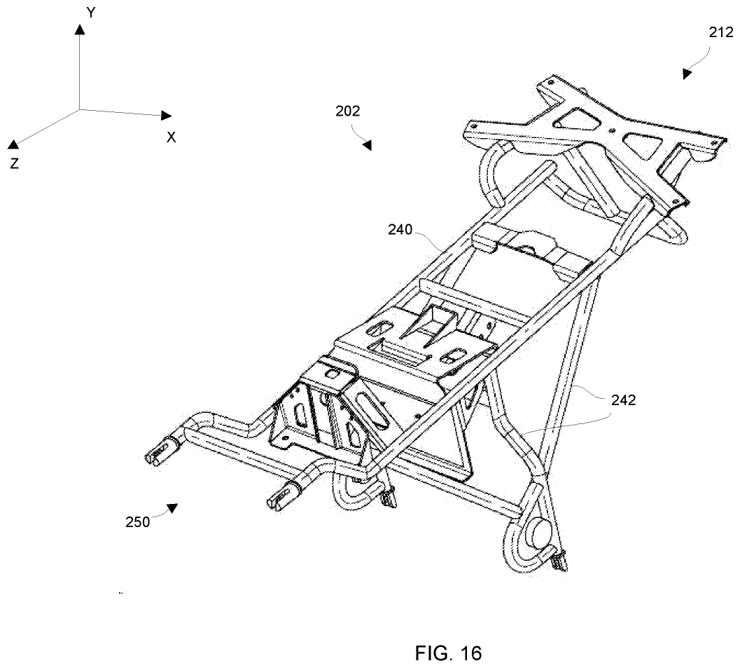

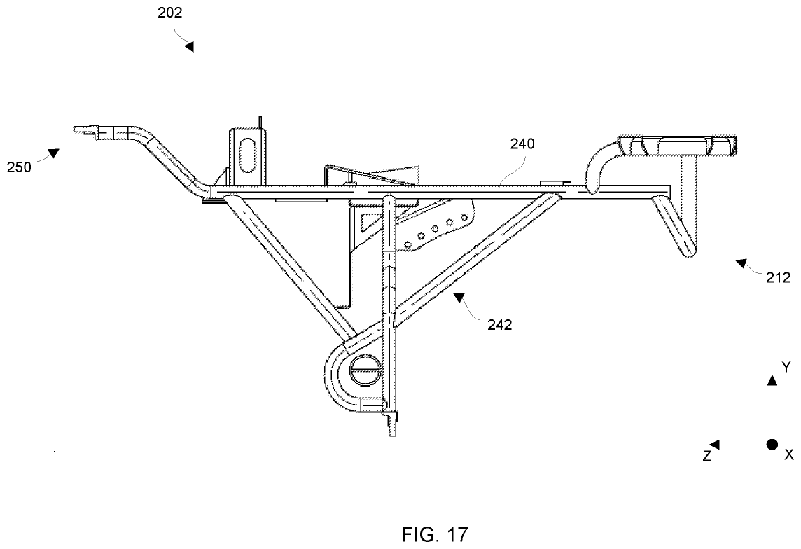

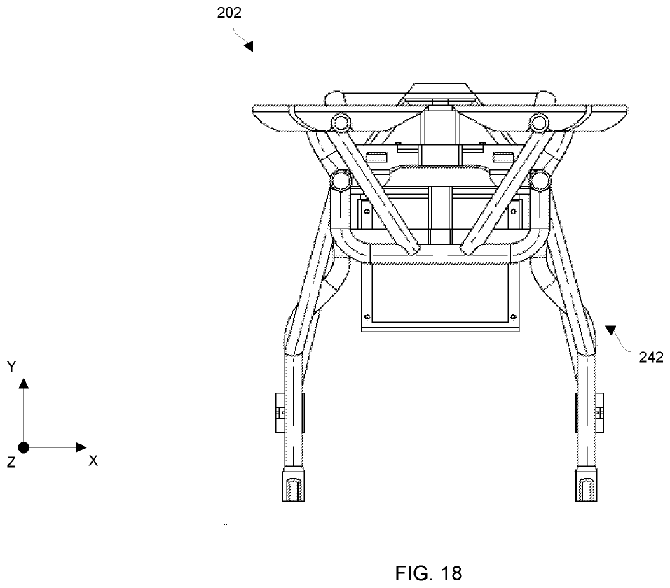

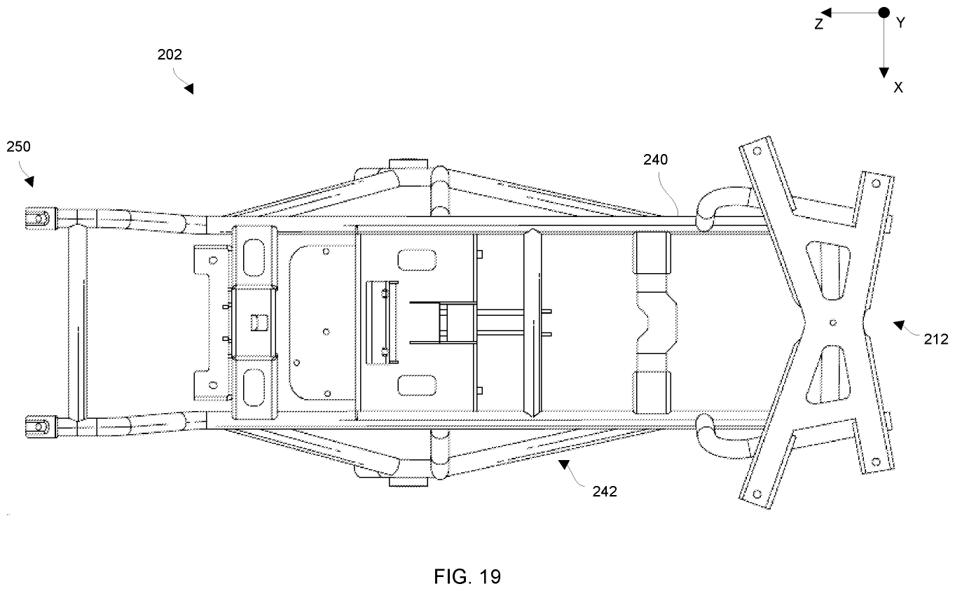

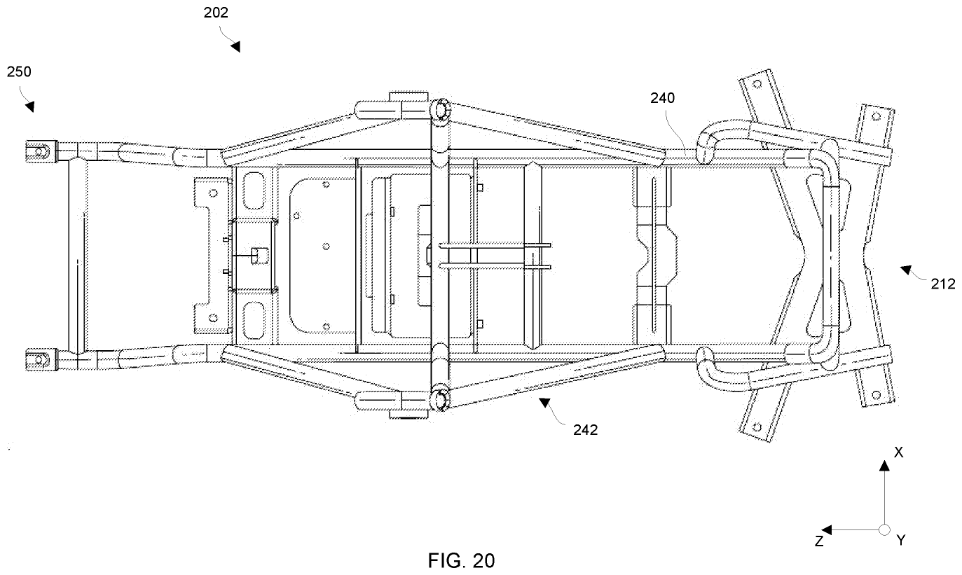

FIGS. 16-20 show further details of the upper rear sub-frame 202 of the frame 102 in accordance with certain embodiments. FIG. 16 is a perspective view of the upper rear sub-frame 202. FIG. 17 is a side view of the upper rear sub-frame 202. FIG. 18 is a front view of the upper rear sub-frame 202. FIG. 19 is a top view of the upper rear sub-frame 202. FIG. 20 is a bottom view of the upper rear sub-frame 202.

As shown in FIGS. 16-20, the upper rear sub-frame 202 includes an upper support 240 and a set of trusses (or support members) 242. The upper rear sub-frame 202 is constructed and arranged to, among other things, support a seat for a rider. The set of trusses 242 is constructed and arranged to, among other things, maintain the upper support 240 of the upper rear sub-frame 202 above the lower support 220 of the front lower sub-frame 200 once the adjustable youth frame 102 has been assembled (e.g., see FIG. 1).

To connect the front lower sub-frame 200 and the upper rear sub-frame 202, a front region 250 of the upper support 240 of the upper rear sub-frame 202 (FIGS. 16-20) couples with the front section 222 of the front lower sub-frame 200 (FIGS. 10-15). Additionally, the set of trusses 242 of the upper rear sub-frame 202 extends from a rear region 252 of the lower support 220 of the front lower sub-frame 200 to the upper support 240 to maintain the upper support 240 above the lower support 220 (e.g., see FIG. 7). As a result, a reliable and resilient structure is formed to maintain vehicle integrity, as well as support various vehicle componentry and provide access to such vehicle componentry for servicing.

Along these lines and in accordance with certain embodiments, the front lower sub-frame 200 and the upper rear sub-frame 202 encircle the battery assembly when the frame 102 is assembled. That is, the front section 222 and the lower support 220 of the front lower sub-frame 200 and the upper support 240 and the set of trusses 242 of the upper rear sub-frame 202 encircle the battery assembly 104 which mounts to the lower support 220 (e.g., see FIG. 7). Accordingly, the battery assembly 104 is well protected and positioned within the adjustable youth frame 102 for ideal vehicle handling and control.

Moreover, equipment within a central space 244 formed by the front lower sub-frame 200 and the upper rear sub-frame 202 may be easily accessed (e.g., for servicing, testing, replacement, etc.). Along these lines, the central space 244 is conveniently reachable and open even when the tires 112 are installed (e.g., see FIG. 1).

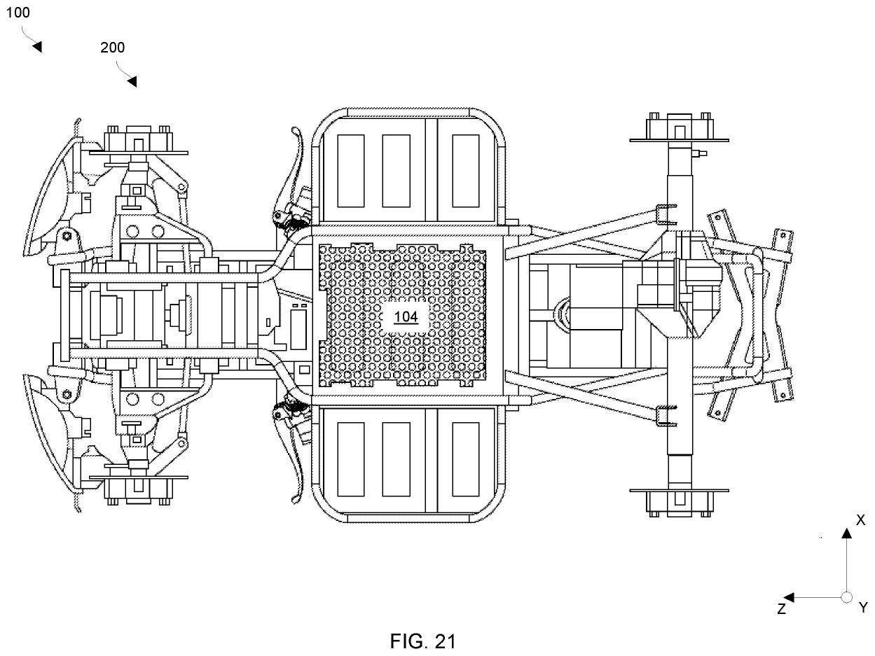

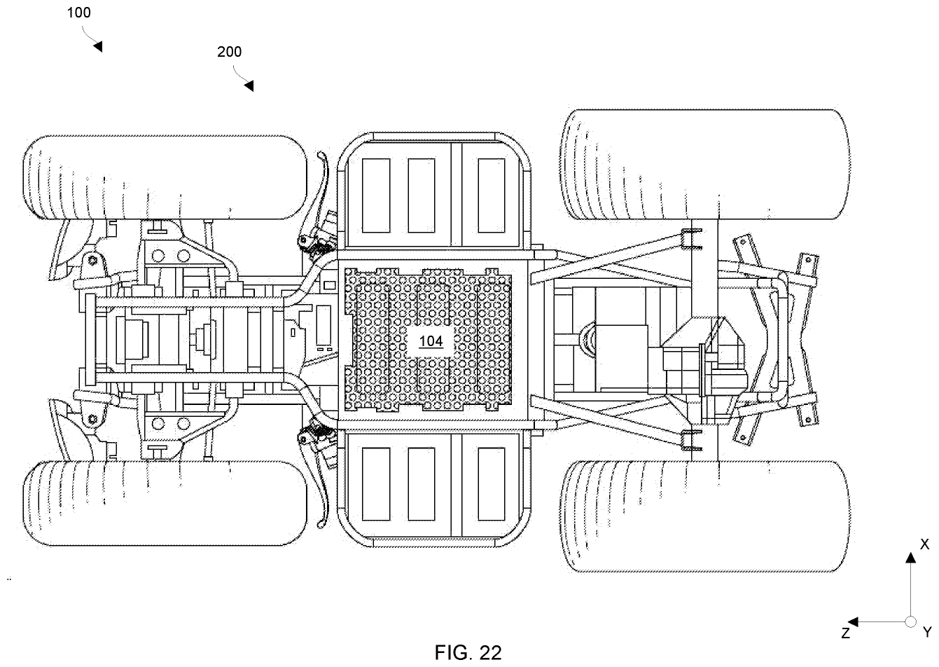

FIGS. 21 and 22 show further positioning details for the battery assembly 104 within the vehicle 100 in accordance with certain embodiments. FIG. 21 shows the vehicle 100 without the tires 112. FIG. 22 shows the vehicle 100 with the tires 112.

As shown in FIGS. 21 and 22 and in accordance with certain embodiments, the battery assembly 104 is centrally positioned on the frame 200 along the X-axis (laterally). Accordingly, the weight of the battery assembly 104 does not bias the vehicle 100 in any lateral direction. Rather, the weight of the battery assembly 104 is centered (and low) so that there is no problematic rocking or leaning to any side (i.e., to the right or left).

As further shown in FIGS. 21 and 22 and in accordance with certain embodiments, the battery assembly 104 is centrally positioned on the frame 200 along the Z-axis (front to back). Accordingly, the weight of the battery assembly 104 does not bias the vehicle 100 in the forward or rearward direction. Rather, the weight of the battery assembly 104 is centered (and low) so that there is no imparted tendency (or biasing) to tilt (or rock) forward or backward.

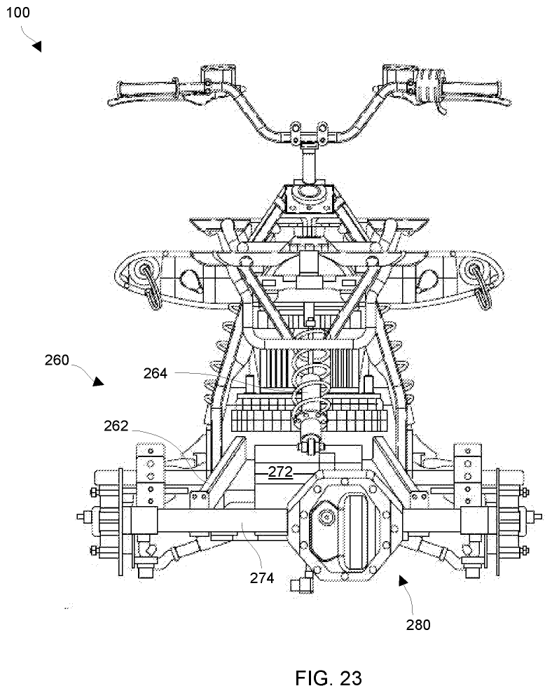

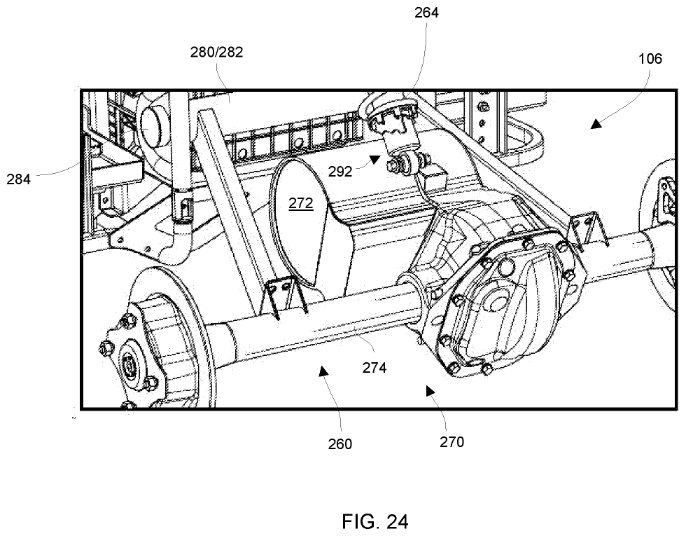

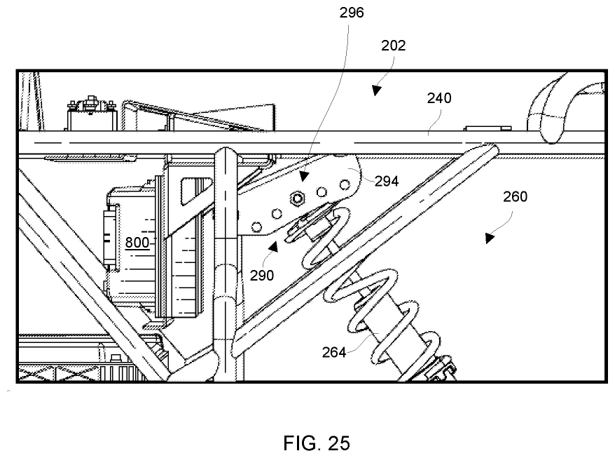

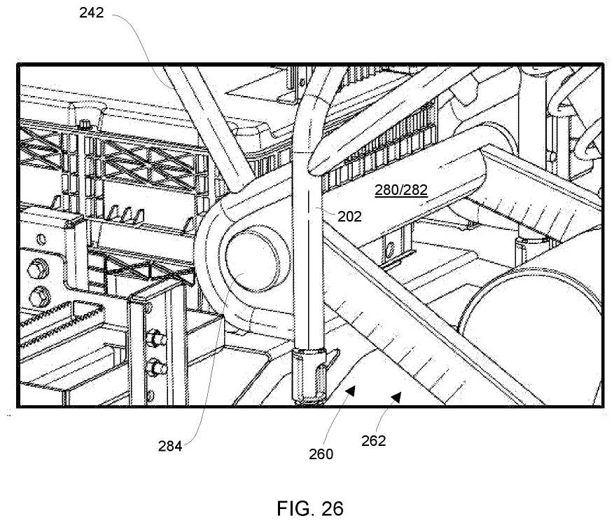

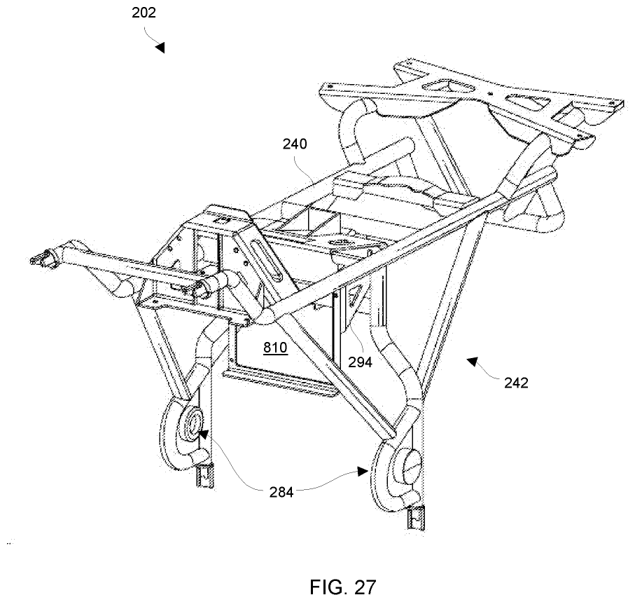

Now, with reference back to FIG. 7 and with further reference to FIGS. 23 through 27, the frame 200 of the adjustable youth electric off-road vehicle 100 further includes a swing arm assembly 260 in accordance with certain embodiments. FIG. 7 is a vehicle side view showing the swing arm assembly 260. FIG. 23 is a rear view showing the swing arm assembly 260. FIG. 24 is rear perspective view of a portion of the swing arm assembly 260. FIG. 25 is side view of another portion of the swing arm assembly 260. FIG. 26 is perspective view of yet another portion of the swing arm assembly 260. FIG. 27 is a perspective view of the upper rear sub-frame 202 which is constructed and arranged to couple with the swing arm assembly 260.

As shown, the swing arm assembly 260 includes a swing arm framework 262 and a shock absorber 264 which couples with the swing arm framework 262 (e.g., see FIGS. 7 and 23-24). The swing arm framework 262 and the shock absorber 264 operate to support a variety of vehicle components 270 such as a portion 272 of the electric propulsion system 106 and a rear axle 274.

As best seen in FIGS. 26 and 27, the swing arm framework 262 (e.g., an arrangement of interconnected support beams) includes a first end 280 that pivotably couples with the upper rear sub-frame 202. In accordance with certain embodiments, the first end 280 takes the form of a pivot tube (or cross beam) 282 and the upper rear sub-frame 202 includes pivot mounts (or mounting points) 284 where the trusses 242 of the upper rear sub-frame 202 meet. The mounting points 284 hold the first end 280 in place but allow the swing arm framework 262 (and thus the rear axle 274, also see FIGS. 7 and 23-24) to pivot relative to the rest of the vehicle 100.

As best seen in FIGS. 23 through 25, the shock absorber 264 includes a first shock absorber end 290 (FIG. 25) that couples with the upper rear sub-frame 202 and a second shock absorber end 292 (FIG. 24) adjacent the rear axle 274. The shock absorber 264 is constructed and arranged to control lessen the rebounding/bouncing reaction of the rear axle 274 during vehicle operation (e.g., via compression/dampening/etc.).

In accordance with certain embodiments, the upper rear sub-frame 202 includes a shock mounting bracket 294 that defines a series (or array) of shock absorber attachment points 296 (e.g., see FIGS. 7 and 25). Along these lines, the shock mounting bracket 294 may be positioned underneath a portion of the upper support 240 and flanked by left and right sets of trusses 242 of the upper rear sub-frame 202 (FIG. 27). When the first shock absorber end 290 attaches to the shock mounting bracket 294 at one of the series of shock absorber attachment points 296, the swing arm assembly 260 then supports the rear axle 274 at a particular predefined angular displacement relative to the vehicle 100 (e.g., relative to the lower support 220 of the front lower sub-frame 200, see FIGS. 10 through 15) depending on which of the attachment points 296 the first shock absorber end 292 couples with (e.g., see FIG. 25).

As mentioned earlier, the swing arm framework 262 supports a portion 272 of the electric propulsion system 106 (e.g., see FIG. 24). In accordance with certain embodiments, this portion 272 includes an electric motor that runs on electric power from the battery assembly 104 and linkage (e.g., a set of gears, a belt, combinations thereof, etc.) that conveys drive from the electric motor to the rear axle 274. It should be understood that the electric motor may be supported by the swing arm framework 262 and oriented relative to the rear axle 274 to link with the rear axle 274 in a variety of different ways.

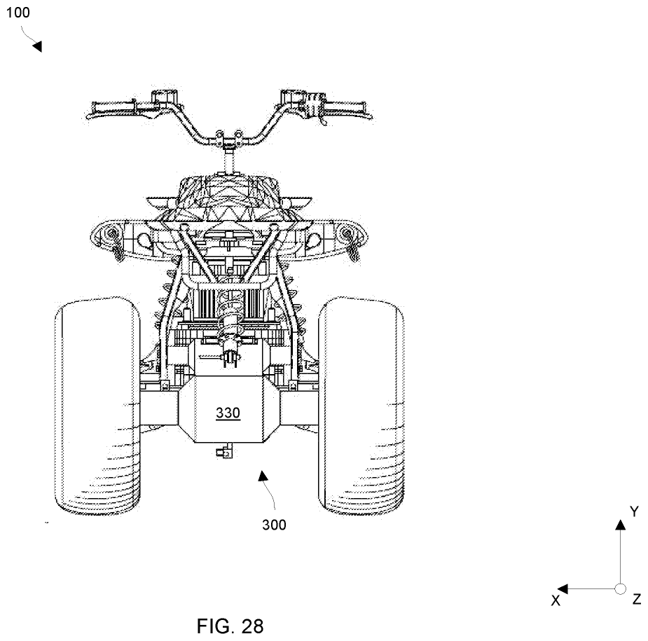

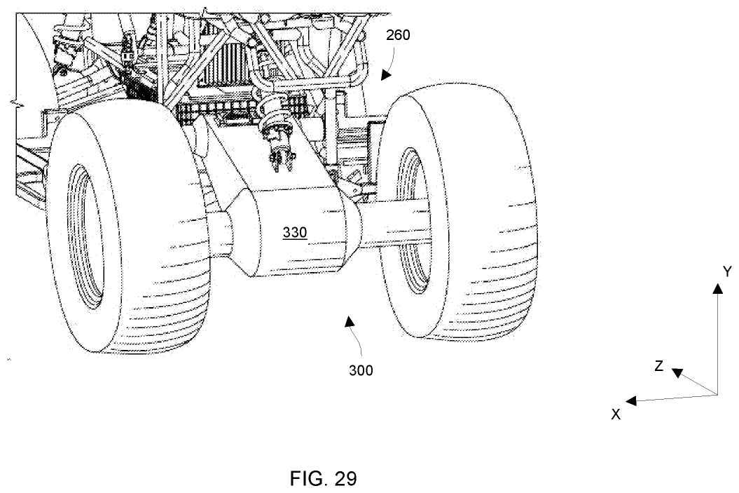

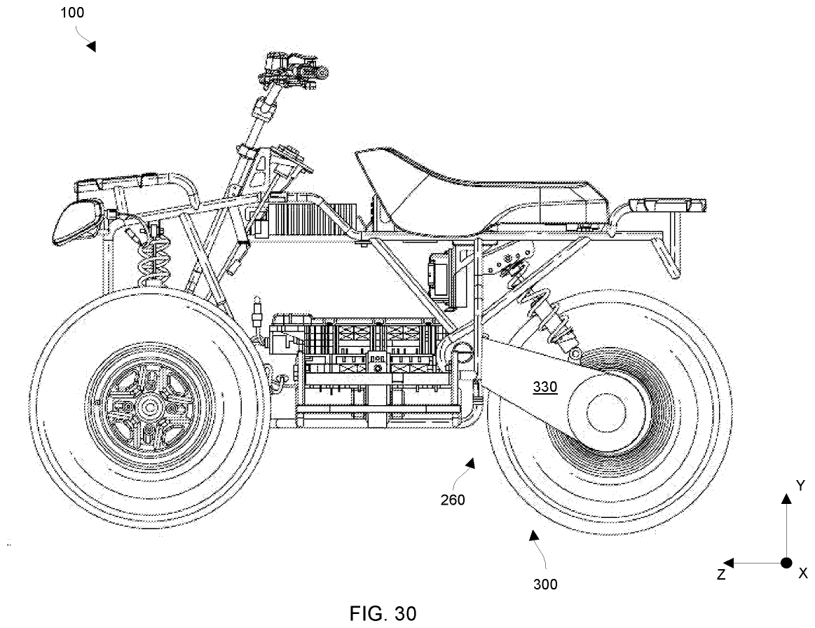

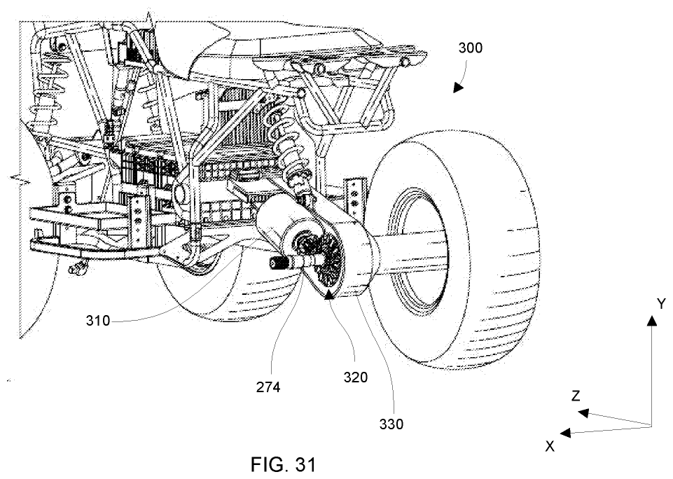

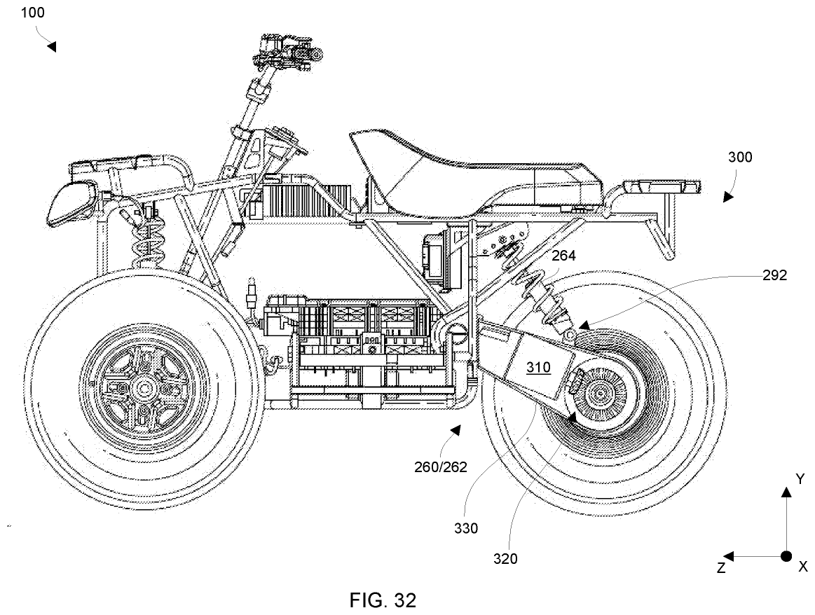

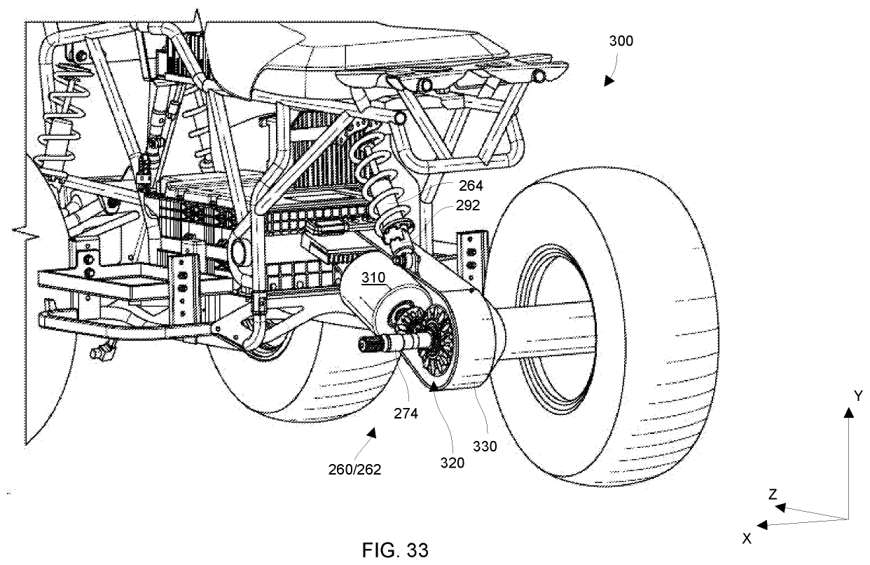

FIGS. 28 through 33 show a first swing arm arrangement 300 which is suitable for use by the adjustable youth electric off-road vehicle 100 in accordance with certain embodiments. FIG. 28 is a rear view of the first swing arm arrangement 300. FIG. 29 is a rear perspective view of the first swing arm arrangement 300. FIG. 30 is a side view of the first swing arm arrangement 300. FIG. 31 is another rear perspective view of the first swing arm arrangement 300. FIG. 32 is another side view of the first swing arm arrangement 300. FIG. 33 is yet another rear perspective view of the first swing arm arrangement 300.

As shown in FIGS. 28 through 33, the first swing arm arrangement 300 generally resides beneath the seat 302 (FIG. 30) and orients an electric motor 310 of the electric propulsion system 106 in a perpendicular (or transverse) manner relative to the rear axle 274 (FIGS. 31 and 32). That is, the rear axle 274 has an axis of rotation along the X-axis, and the electric motor 310 has an axis of rotation that is perpendicular to the X-axis. Accordingly, the electric motor 310 is able to engage the rear axle 274 via linkage 320 (e.g., a set of 90 degree gears). It should be understood that the linkage 320 may further include other components such as bearings, a differential or transmission, an oil pan, combinations thereof, etc. and/or may take a variety of other forms such as a gear box, a belt drive, combinations thereof, etc.

As further shown in FIGS. 28 through 33, the first swing arm arrangement 300 may further include a housing 330 which maintains at least a portion of the rear axle 274, the electric motor 310, and/or the linkage 320 thus interconnecting the rear axle 274 and the electric motor 310. Part of the housing 330 (e.g., a cover or plate) has been removed in FIGS. 31 through 33 to show such details in accordance with certain embodiments.

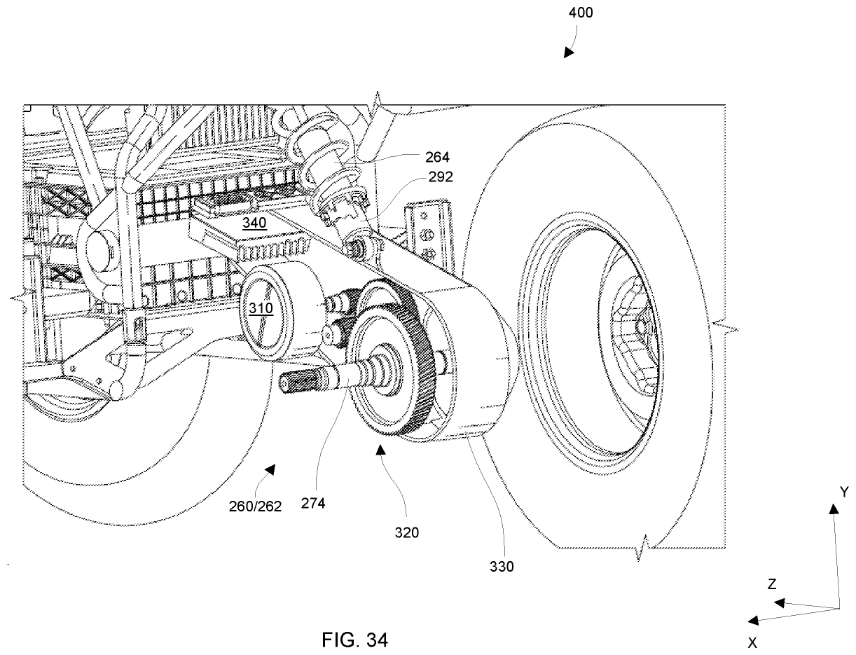

By way of example only, the second end 292 of the shock absorber 264 fastens to the housing 330 (e.g., see FIGS. 32 and 33). Accordingly, in this first swing arm arrangement 300, the housing 330 itself forms part of the swing arm framework 262 of the swing arm assembly 260. That is, in addition to protecting the electric motor 310 and the linkage 320, the housing 330 supports the rear axle 274 and holds the electric motor 310 in place for proper engagement with the rear axle 274 via the linkage 320 (e.g., the housing 310 serves as a gear housing or gear enclosure). Further details will now be provided with reference to FIGS. 34 through 36.

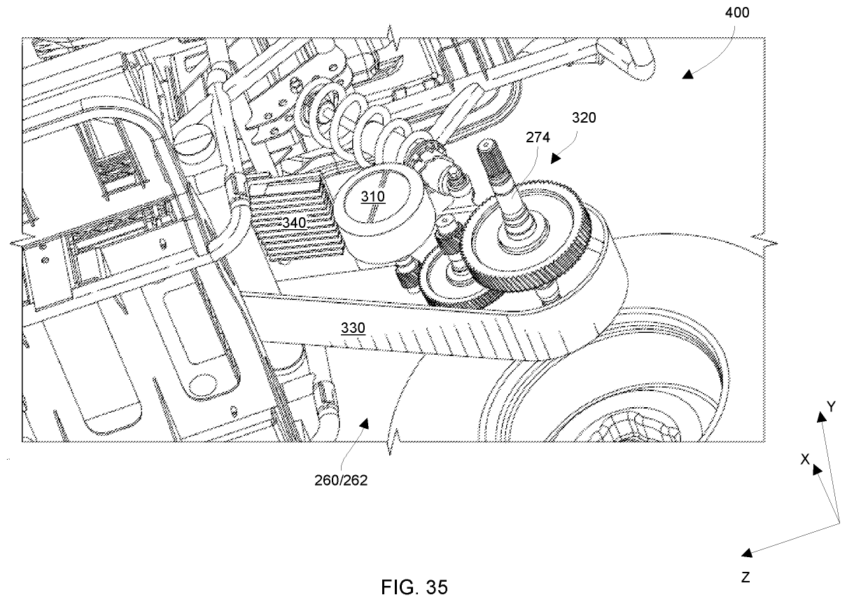

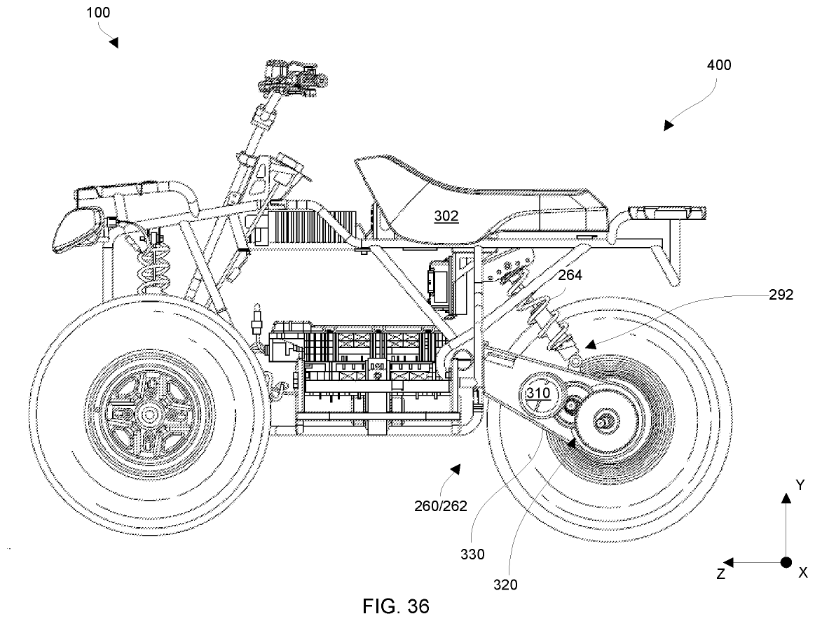

FIGS. 34 through 36 show a second swing arm arrangement 400 which is suitable for use by the adjustable youth electric off-road vehicle 100 in accordance with certain embodiments. FIG. 34 is a rear perspective view of the second swing arm arrangement 400. FIG. 35 is another rear/underneath perspective view of the second swing arm arrangement 400. FIG. 36 is a side view of the second swing arm arrangement 400.

In contrast to the first swing arm arrangement 300, the second swing arm arrangement 400 orients the electric motor 310 in a parallel (or longitudinal) manner relative to the rear axle 274 (e.g., see FIGS. 34 and 35). That is, the rear axle 274 has an axis of rotation along the X-axis, and the electric motor 310 also has an axis of rotation that is along the X-axis and thus parallel to the axis of rotation of the rear axle 274. Accordingly, the electric motor 310 is able to engage the rear axle 274 via the linkage 320 (e.g., a set of gears) without needing any 90 degree gears.

As in the first swing arm arrangement 300, a housing 330 of the second swing arm arrangement 400 may maintain at least a portion of the rear axle 274, the electric motor 310, and/or the linkage 320 interconnecting the rear axle 274 and the electric motor 310. Parts of the housing 330 have been removed in FIGS. 33 through 36 to show further details.

Again, by way of example only, the second end 292 of the shock absorber 264 fastens to the housing 330 (e.g., see FIGS. 34 and 36). Accordingly, in the second swing arm arrangement 400, the housing 330 itself forms part of the swing arm framework 262 of the swing arm assembly 260. In addition to protecting the electric motor 310 and the linkage 320, the housing 330 may support the rear axle 274 and hold the electric motor 310 in place for proper engagement with the rear axle 274 via the linkage 320.

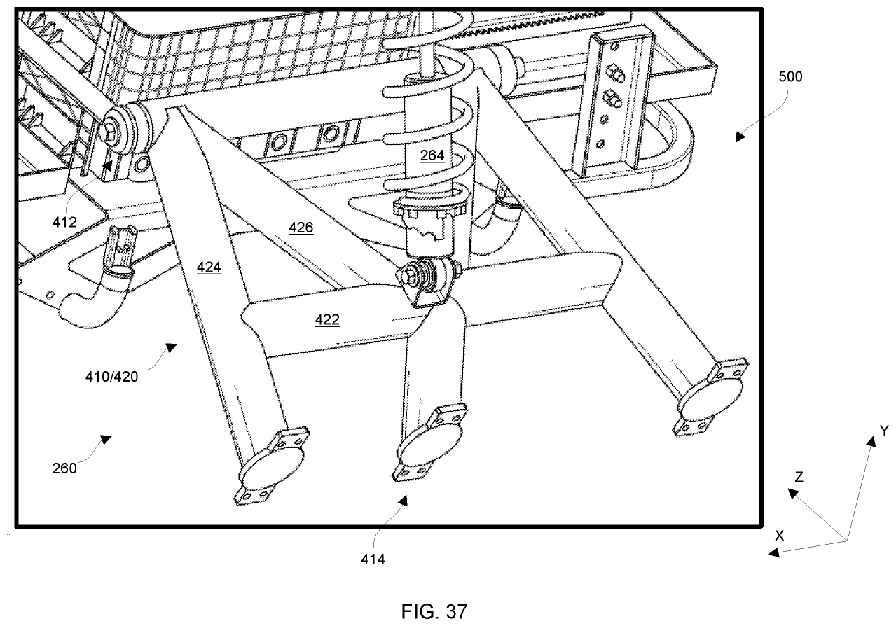

It should be understood that, in addition to the electric motor 310 and linkage 320, other componentry may be disposed within the housing 330. For example, as shown in FIGS. 34 and 35, the housing 330 may further contain the motor controller 340 which controls the electric motor 310. Further details will now be provided with reference to FIGS. 37 through 40.

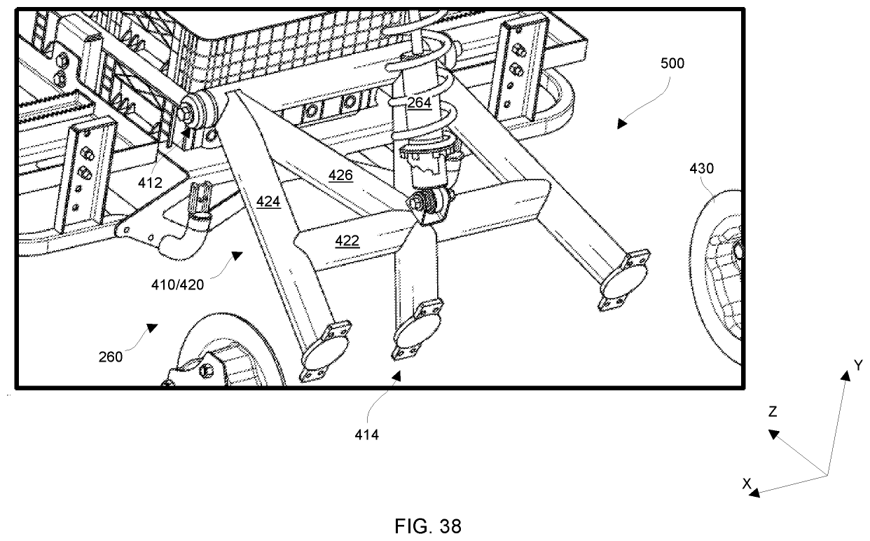

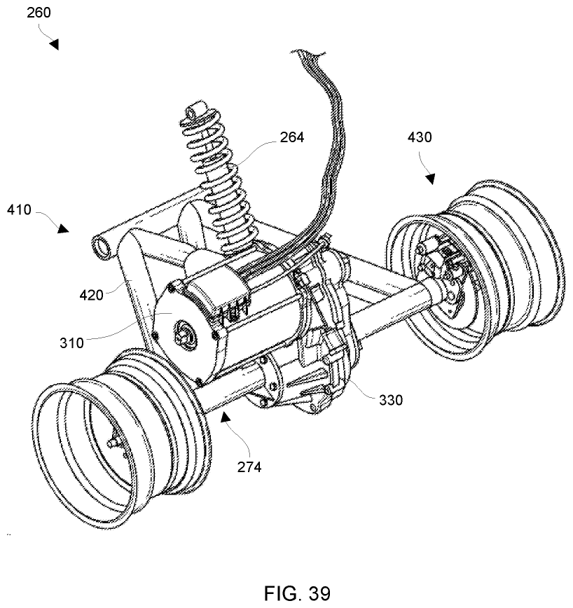

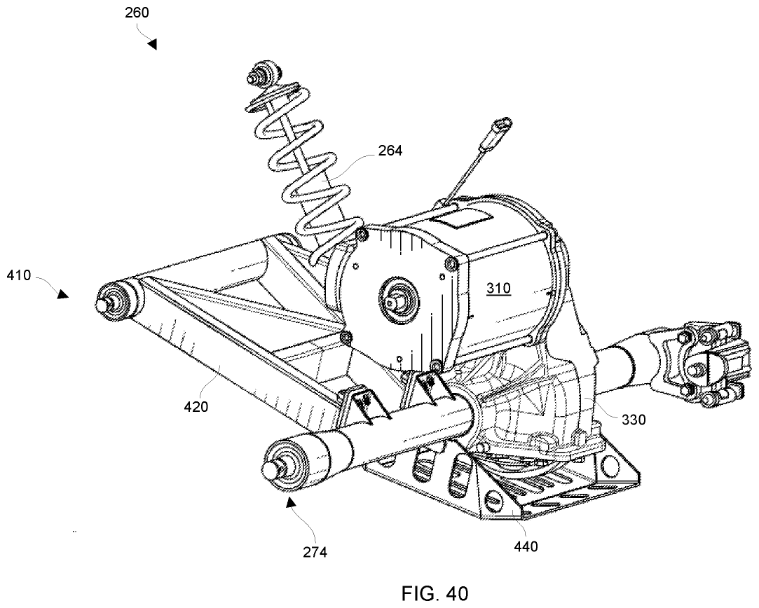

FIGS. 37 through 40 show a third swing arm arrangement 500 which is suitable for use by the adjustable youth electric off-road vehicle 100 in accordance with certain embodiments. FIG. 37 is a rear perspective view of a portion of the third swing arm arrangement 500. FIG. 38 is another rear perspective view of another portion of the third swing arm arrangement 500. FIG. 39 is a rear perspective view of yet another portion of the third swing arm arrangement 500. FIG. 40 is a rear perspective view of an alternative portion of the third swing arm arrangement 500.

In contrast to the first swing arm arrangement 300 and the second swing arm arrangement 400, the third swing arm arrangement 500 has the shock absorber 264 mounted to a set of support beams 410 of the swing arm assembly 260. Along these lines, the set of support beams 410 may form at least a portion of the swing arm framework 262 having a pivot end 412 that pivotably couples with the upper rear sub-frame 202, e.g., see the pivot mounting points 284 in FIGS. 26 and 27. Additionally, the second end 292 of the shock absorber 264 fastens to a location of the set of support beams 410 that is offset from the pivot mounting points 284 between the pivot end 412 and an opposite end 414 to enable the swing arm framework 262 to pivot during vehicle operation.

In accordance with certain embodiments, the set of support beams 410 may include multiple members 420 such as one or more lateral members 422 extending along the X-axis, and one or more extending members 424 that extend the length of the swing arm framework 262, and one or more bracing member 426 to provide further strength to the swing arm framework 262. By way of example, the members 420 may have a tubular cross-section for strength and/or manufacturability (see FIGS. 37 and 38).

Additionally, the set of support beams 410 may be constructed and arranged to mechanically fasten to other componentry at the end 414 that is opposite the pivot end 412. For example, the end 414 may define features (e.g., holes, tabs, combinations thereof, etc.) to enable componentry such as the electric motor 310, the housing (and/or gear box) 330, the rear axle 274, etc. to attach thereto. Along these lines, wheel features 430 of the vehicle 100 are included in FIG. 38 for illustration purposes.

FIG. 39 shows, by way of example, the electric motor 310, the housing (and/or gear box) 330, and the rear axle 274 supported by the set of support beams 410. In some arrangements, the swing arm assembly 260 as shown in FIG. 39 may be manufactured as a unit which is then fastened to other (e.g., remaining) portions of the frame 102 to facilitate vehicle manufacturing.

It should be understood that various modifications and/or enhancements may be made to the swing arm assembly 260. For example, as shown in FIG. 40, the members 420 of the set of support beams 410 have rectangular (or even I-beam) cross-sections instead of the round or tubular cross-sections previously shown in FIG. 39. Such rectangular cross-sectioned members 420 may be solid (rather than hollow tubular cross-sectioned members) for strength, manufacturability, etc. Additionally, if the swing arm assembly 260 is provided as a unit for attachment to other portions of the vehicle 100, various features may be omitted from the swing arm assembly 260 until later (e.g., certain wheel features 430, etc.). Furthermore, various features may be added to the swing arm assembly 260 before attachment to the other portions of the vehicle 100 such as a skid plate (or debris guard) 440 to protect the rear axle 274 (see FIG. 40).

In some arrangements, the skid plate 440 fastens to the set of support beams 410 via hardware and supports the rear axle 274 (perhaps with contributing support from the gear box 330. Furthermore, the skid plate 440 may define a set of holes for drainage, ventilation, debris release, etc.

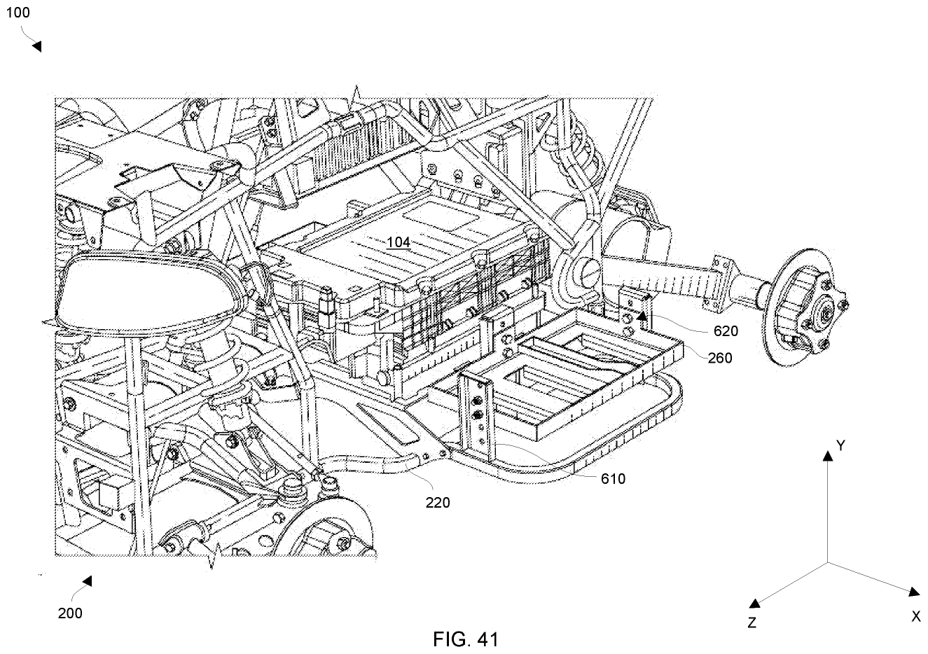

In some arrangements, the housing 330 of the various arrangements 300, 400, 500 provides a water tight seal (i.e., is a sealed in case) to prevent water and other debris from interfering with the drive train. Further details will now be provided with reference to FIG. 41.

FIG. 41 shows an adjustable foot rest feature which is provided by the adjustable youth electric off-road vehicle 100. Along these lines, the adjustable youth frame 102 further includes a set of adjustable foot rests 600 which couples with the front lower sub-frame 200. The set of adjustable foot rests 600 flank the battery assembly 104 (also see FIGS. 21 and 22) thus promoting the rider to reside over and slightly behind the battery assembly 104. Such positioning provides weight distribution which is optimized for vehicle handling and rider control.

As shown in FIGS. 41 and 23, the adjustable foot rests 600 couple with the front lower section 220 of the front lower sub-frame 200 at any of the variety of different foot rest heights to accommodate any of the different youth sizes. To this end, the front lower section 220 provides foot rest support members 610 on the left side of the vehicle 100 and other foot rest support members 610 on the right side of the vehicle 100 to support the adjustable foot rests 600. The foot rest support members 610 extend upwardly in the positive Y-direction to provide mounting locations at different heights. Accordingly, the adjustable youth frame 102 is able to adjust to accommodate the rider as the rider grows taller and the rider's legs grow longer.

In some arrangements, there are exactly three foot rest support members 610 on each side of the vehicle 100. That is, there is no foot rest support member 610 on the outermost side of the adjustable foot rests 600 to enable the rider's feet to exit freely from the foot rests 600.

It should be understood that, even though the battery assembly 104 is disposed between the foot rest support members 610 on each side of the vehicle 100, the battery assembly 104 may be conveniently accessed without interference from the foot rest support members 610. That is, the battery assembly 104 may be conveniently inspected, tested, removed, re-installed, and so on.

In some arrangements, the adjustable foot rests 600 attach to each foot rest support members 610 at multiple points (see arrow 620 in FIG. 41). As a result, the adjustable foot rests 600 robustly and reliably fasten to the front lower sub-frame 200 of the vehicle 100 and are easily able to bear the full weight of the rider (e.g., as the rider boards, exits, stands on, etc. the vehicle 100).

It should be understood that other portions of the vehicle 100 may be adjusted to accommodate different youth sizes. For example, in accordance with certain embodiments, the adjustable youth frame 102 further includes an adjustable (or modular) handlebar assembly 700 that provides a variety of different handlebar heights and/or positions.

As conveniently seen in FIGS. 7 and 8, such a handlebar assembly 700 may couple with the front lower sub-frame 200 of the adjustable youth frame 102. The handlebar assembly 700 includes and extendable and/or collapsible neck 702, a neck adjuster 704, a handlebar 706, and a handlebar adjuster 708.

The neck adjuster 704 is constructed and arranged to hold and/or release the collapsible neck 702 of the handlebar assembly 700 thus enabling the neck 702 to be positioned to a proper length to accommodate the rider. In some arrangements, when the neck adjuster 704 is loosened, the neck 702 is able to extend and/or retract (e.g., in a sliding or telescoping manner). Once the neck 702 is moved to its proper length, the neck adjuster 704 is re-tightened to hold the neck 702 at that length.

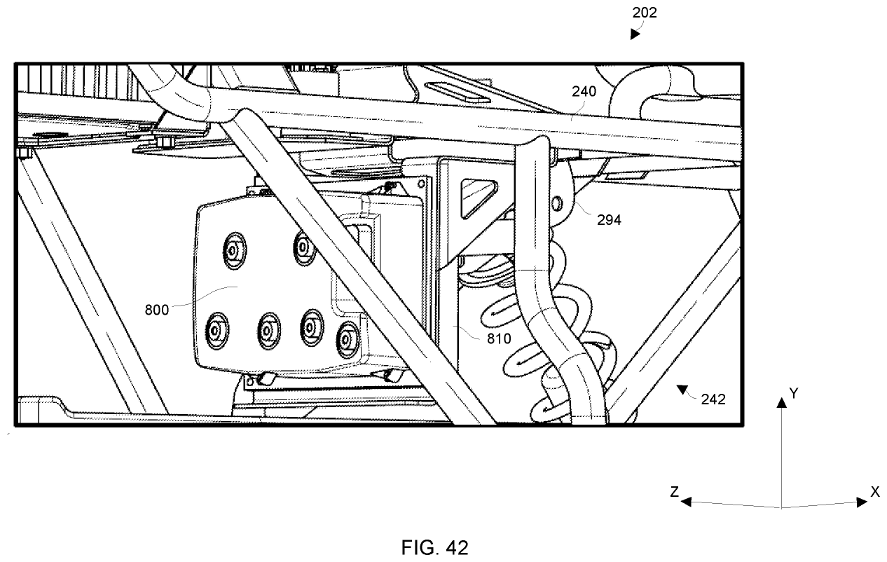

Likewise, the handlebar adjuster 708 is constructed and arranged to hold and/or release the handlebar 706 thus enabling the handlebar 706 to be rotated about the X-axis to a comfortable orientation to accommodate the rider. In some arrangements, when the handlebar adjuster 708 is loosened, the handlebar 706 is able to rotate (or turn/pivot) about the X-axis to an optimal angle for the rider to reach the handlebar grips as well as access controls mounted on the handlebar 706. Once the handlebar 706 is moved to its proper orientation, the handlebar adjuster 708 is re-tightened to hold the handlebar 706 at that angle. Further details will now be provided with reference to FIG. 42.

FIG. 42 is a detailed perspective view of a portion of the vehicle 100. As shown in FIG. 42, the electric propulsion system 106 further includes a contactor 800 which controls electrical access to the battery assembly 104. In accordance with certain embodiments, the contactor 800 fastens to and derives support from the upper rear sub-frame 202.

Along these lines, the motor controller 800 may mount to a front portion 810 of the shock mounting bracket 294 (also see FIGS. 27 and 42). Here, the contactor 800 is positioned underneath a portion of the upper support 240 and flanked by the set of trusses 242 of the upper rear sub-frame 202 in a manner similar to that of the shock mounting bracket 294. As best seen in FIGS. 30, 32, and 36, the contactor 800 may reside just in front of and below the rider's seat 302 which is supported by the upper support 240. This configuration is well-suited for providing access to the contactor 800 (e.g., underneath the upper support 240 and in front of the shock mounting bracket 294) while the first shock absorber end 290 of the shock absorber 264 is accessed from the opposite side of the shock mounting bracket 294 (e.g., to change an attachment point 296 of the shock absorber 264).

The contactor 800 closes to allow electrical access to the battery assembly 104 (e.g., to recharge the battery assembly 104, to supply electric power to the electric motor 310, etc.). The contactor 800 opens to prevent electrical access to the battery assembly 104 (e.g., while the vehicle 100 is turned off and stored).

It should be understood that the battery assembly 104 may receive charge from a variety of sources. Such sources include an onboard electric charger, an external electric charger, the electric motor 310 (e.g., during regenerative braking), and so on.

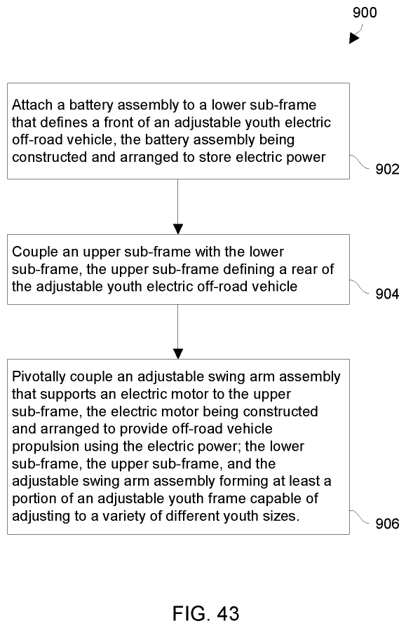

As shown in FIG. 7, the vehicle 100 may include an onboard electric charger 810 which charges the battery assembly 104 when connected to an external power source (e.g., street power). In some arrangements, the onboard electric charger 810 is disposed between the handlebar assembly 700 and the seat 302. Here, the onboard electric charger 810 attaches to the upper support 240 of the upper rear sub-frame 202 and sits atop the upper support 240 with the seat 302 for convenient access. Such a position provides further weight balancing for the vehicle 100. Further details will now be provided with reference to FIG. 43.

FIG. 43 shows a method 900 of providing an adjustable youth electric off-road vehicle. Such a method may be performed by a manufacturer (e.g., an assembly line, robotics, manually, combinations thereof, etc.) and equips the vehicle with an adjustable youth frame.

At 902, manufacturer attaches a battery assembly to a lower sub-frame that defines a front of the adjustable youth electric off-road vehicle (e.g., also see the front lower sub-frame 200 in FIGS. 7 and 10). The battery assembly is constructed and arranged to store electric power.

At 904, the manufacturer couples an upper sub-frame with the lower sub-frame (e.g., also see the rear upper sub-frame 202 in FIGS. 7 and 16). The upper sub-frame defines a rear of the adjustable youth electric off-road vehicle.

At 906, the manufacturer pivotally couples an adjustable swing arm assembly that supports an electric motor to the upper sub-frame (e.g., also see the swing arm assembly 212 in FIG. 7). The electric motor is constructed and arranged to provide off-road vehicle propulsion using the electric power. The lower sub-frame, the upper sub-frame and the adjustable swing arm assembly form an adjustable youth frame capable of adjusting to a variety of different youth sizes.

It should be appreciated that the adjustable youth electric off-road vehicle 100 provides rider flexibility, customizability, and adaptability in that various portions of the vehicle 100 may be adjusted to accommodate rider changes over time. Accordingly, the rider does not need to worry about the adjustable youth electric off-road vehicle 100 not fitting properly as the rider matures. Instead, the rider may rely various adjustments made to particular features of the adjustable youth electric off-road vehicle 100 to accommodate rider changes over time (e.g., changes in weight, leg lengths, arm lengths, etc.).

For example and as mentioned earlier, the angle of the swing arm assembly 212 relative to the other portions of the vehicle 100 such as the frame 102, the seat 302, and so on may be adjusted. Along these lines, by changing the particular attachment point 296 for the first end 290 of the shock absorber 264 (e.g., see FIG. 25), the vehicle 100 is able to provide different seat heights (from the ground), different suspension behavior, and so on.

Additionally, as mentioned earlier, the heights of the footrests 600 may be adjusted. Here, the hardware holding the footrests 600 to the front lower sub-frame 200 may be removed and re-installed to raise and/or lower the footrests 600 and thus accommodate the rider as the rider's legs grown in length over time.

Furthermore, as mentioned earlier, the handlebar assembly 700 may be adjusted to provide different youth sizes. Along these lines, the handlebar neck 702 may be lengthened or compressed to accommodate changes in the rider's height. Additionally, the handlebar 706 may be rotated to move the handlebar grips and controls closer to or further away from the seat 302 to accommodate changes in the rider's arm lengths.

It should be understood that the above-described adjustments can be provided at the outset, e.g., when the rider takes possession of the vehicle 100 from the manufacturer. Additionally, such adjustments may be provided thereafter (e.g., certain adjustments may be made by bringing the vehicle 100 back for servicing, at home, on the road, combinations thereof, etc.).

As described above, improved techniques are directed to utilizing an adjustable youth frame 102 within an adjustable youth electric off-road vehicle 100. Such techniques may enable the frame 102 to adjust to a variety of different youth sizes to accommodate rider changes over time. Along these lines, the vehicle 100 may include an adjustable swing arm assembly 212 for setting different vehicle heights, different foot-rest settings for controlling the distance between the seat 302 and the foot-rests 600, a modular and/or adjustable handlebar assembly 700 to change the distance between the seat and certain handlebar controls, combinations thereof, and so on. Moreover, the placement and/or configuration of various electric components such as the battery, the electric motor, the motor controller, etc. on such a frame enable the adjustable youth electric off-road vehicle to be easily constructed, adjusted for rider changes, and/or serviced over time.

While various embodiments of the present disclosure have been particularly shown and described, it will be understood by those skilled in the art that various changes in form and details may be made therein without departing from the spirit and scope of the present disclosure as defined by the appended claims.

For example, in accordance with certain embodiments, there is a youth electric-ATV including:
a new frame,
a variety of electric components positioned on the new frame,
adjustable foot rests,
a swing arm that mounts securely to an upper frame (not lower frame),
a modular upper shock mount,
a swing arm design with an axle bolted thereto,
modular handlebars, and
an integrated swing arm module that integrates electric components.
   Such electrical components include a battery for storing electric power, and an electric motor that provides vehicle propulsion using the electric power from the battery. Accordingly, it should be appreciated that the weight distribution and servicing requirements of the electric-ATV may differ significantly from a traditional ATV having a combustion engine, a fuel tank, a radiator, an exhaust system, and so on.

In some arrangements, the adjustable youth frame includes a front lower sub-frame defining a front of the adjustable youth electric off-road vehicle. Additionally, adjustable youth frame includes an upper rear sub-frame that couples with the front lower sub-frame, the upper rear sub-frame defining a rear of the adjustable youth electric off-road vehicle.

In some arrangements, the front lower sub-frame of the adjustable youth frame includes a lower support constructed and arranged to support the battery assembly, and a front section that extends upwardly from a front region of the lower support to define the front of the adjustable youth electric off-road vehicle.

In some arrangements, the upper rear sub-frame of the adjustable youth frame includes an upper support constructed and arranged to support a seat for a rider, and a set of trusses that maintains the upper support of the upper rear sub-frame above the lower support of the front lower sub-frame.

In some arrangements, the front section and the lower support of the front lower sub-frame and the upper support and the set of trusses of the upper rear sub-frame encircle the battery assembly.

In some arrangements, a front region of the upper support of the upper rear sub-frame couples with the front section of the front lower sub-frame. Additionally, the set of trusses of the upper rear sub-frame extends from a rear region of the lower support of the front lower sub-frame to the upper support to maintain the upper support above the lower support.

In some arrangements, the upper support of the upper rear sub-frame is further constructed and arranged to support a battery charger between the seat for the rider and the front section of the front lower sub-frame.

In some arrangements, the upper rear sub-frame is constructed and arranged to support a motor controller between the battery assembly and the upper support.

In some arrangements, the adjustable youth frame further includes an adjustable swing arm assembly constructed and arranged to support a rear axle at a variety of different predefined angular displacements relative to the lower support of the front lower sub-frame to accommodate the different youth sizes.

In some arrangements, the adjustable swing arm assembly includes a swing arm framework having a first end that pivotably couples with the upper rear sub-frame and a second end that couples with the rear axle.

In some arrangements, the adjustable swing arm assembly further includes a shock absorber having a first shock absorber end that couples with the upper rear sub-frame and a second shock absorber end adjacent the rear axle.

In some arrangements, the upper rear sub-frame includes a shock mounting bracket that defines a series of shock absorber attachment points. Additionally, the swing arm assembly supports the rear axle at a particular predefined angular displacement relative to the lower support of the front lower sub-frame depending on which of the series of shock absorber attachment points the first shock absorber end couples with.

In some arrangements, the second shock absorber end of the shock absorber attaches to a gear housing that houses a set of gears to turn the rear axle.

In some arrangements, the second shock absorber end of the shock absorber attaches to a set of support beams that form at least a portion of the swing arm framework.

In some arrangements, the front lower section of the adjustable youth frame defines a variety of different foot rest heights. Additionally, the adjustable youth frame further includes a set of foot rests, each foot rest of the set of foot rests being constructed and arranged to couple with the front lower section at any of the variety of different foot rest heights to accommodate any of the different youth sizes.

In some arrangements, the set of foot rests includes a left foot rest and a right foot rest. Additionally, the front lower section of the adjustable youth frame further includes a plurality of left foot rest support members that extend from the lower support to couple with the left foot rest, and a plurality of right foot rest support members that extend from the lower support to couple with the right foot rest.

In some arrangements, the left foot rest couples with three left foot rest support members, and the right foot rest couples with three right foot rest support members. Additionally, the battery assembly is supported by the lower support between the three left foot rest support members and the three right foot rest support members.

In some arrangements, the adjustable youth frame further includes a modular handlebar coupled with the front lower section, the modular handlebar providing a variety of different handlebar heights, and an adjustable swing arm assembly coupled with the upper rear sub-frame to support a rear axle at a variety of different predefined angular displacements relative to the lower support of the front lower sub-frame. Additionally, the variety of different handlebar heights, the variety of different foot rest heights, and the variety of different predefined angular displacements operating to provide the variety of different youth sizes.

In some arrangements, the electric propulsion system includes an electric motor that provides drive to the rear axle in response to the electric power. The electric motor is coupled with and supported by the adjustable swing arm assembly of the adjustable youth frame.

In some arrangements, the electric propulsion system further includes an electric motor controller constructed and arranged to control the electric motor. The electric motor controller is coupled with and supported by the adjustable swing arm assembly of the adjustable youth frame.

By way of example, the vehicle 100 has been described above as being an adjustable youth electric off-road vehicle that utilizes an adjustable youth frame. However, the vehicle 100 may have other form factors, uses, applications, etc. Other vehicle types include personal transport vehicles, golf cars, food and beverage vehicles, hospitality vehicles, utility task vehicles (UTVs), motorcycles, scooters, vehicles for specialized applications, other lightweight ground vehicles and utility vehicles, as well as water craft and air craft.

The scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

What is claimed is:

1. An adjustable youth electric off-road vehicle, comprising:
an adjustable youth frame constructed and arranged to adjust to a variety of different youth sizes;
a battery assembly supported by the adjustable youth frame, the battery assembly being constructed and arranged to store electric power; and
an electric propulsion system supported by the adjustable youth frame, the electric propulsion system being electrically coupled with the battery assembly and constructed and arranged to provide off-road vehicle propulsion using the electric power while the adjustable youth frame is adjusted to any of the different youth sizes.

2. The adjustable youth electric off-road vehicle as in claim 1 wherein the adjustable youth frame includes:
a front lower sub-frame defining a front of the adjustable youth electric off-road vehicle, and
an upper rear sub-frame that couples with the front lower sub-frame, the upper rear sub-frame defining a rear of the adjustable youth electric off-road vehicle.

3. The adjustable youth electric off-road vehicle as in claim 2 wherein the front lower sub-frame of the adjustable youth frame includes:
a lower support constructed and arranged to support the battery assembly, and
a front section that extends upwardly from a front region of the lower support to define the front of the adjustable youth electric off-road vehicle.

4. The adjustable youth electric off-road vehicle as in claim 3 wherein the upper rear sub-frame of the adjustable youth frame includes:
an upper support constructed and arranged to support a seat for a rider, and
a set of trusses that maintains the upper support of the upper rear sub-frame above the lower support of the front lower sub-frame.

5. The adjustable youth electric off-road vehicle as in claim 4 wherein the front section and the lower support of the front lower sub-frame and the upper support and the set of trusses of the upper rear sub-frame encircle the battery assembly.

6. The adjustable youth electric off-road vehicle as in claim 4 wherein a front region of the upper support of the upper rear sub-frame couples with the front section of the front lower sub-frame; and
wherein the set of trusses of the upper rear sub-frame extends from a rear region of the lower support of the front lower sub-frame to the upper support to maintain the upper support above the lower support.

7. The adjustable youth electric off-road vehicle as in claim 4 wherein the upper support of the upper rear sub-frame is further constructed and arranged to support a battery charger between the seat for the rider and the front section of the front lower sub-frame.

8. The adjustable youth electric off-road vehicle as in claim 4 wherein the upper rear sub-frame is constructed and arranged to support a motor controller between the battery assembly and the upper support.

9. The adjustable youth electric off-road vehicle as in claim 3 wherein the adjustable youth frame further includes:
an adjustable swing arm assembly constructed and arranged to support a rear axle at a variety of different predefined angular displacements relative to the lower support of the front lower sub-frame to accommodate the different youth sizes.

10. The adjustable youth electric off-road vehicle as in claim 9 wherein the adjustable swing arm assembly includes:
a swing arm framework having a first end that pivotably couples with the upper rear sub-frame and a second end that couples with the rear axle.

11. The adjustable youth electric off-road vehicle as in claim 10 wherein the adjustable swing arm assembly further includes:
a shock absorber having a first shock absorber end that couples with the upper rear sub-frame and a second shock absorber end adjacent the rear axle.

12. The adjustable youth electric off-road vehicle as in claim 11 wherein the upper rear sub-frame includes a shock mounting bracket that defines a series of shock absorber attachment points, the swing arm assembly supporting the rear axle at a particular predefined angular displacement relative to the lower support of the front lower sub-frame depending on which of the series of shock absorber attachment points the first shock absorber end couples with.

13. The adjustable youth electric off-road vehicle as in claim 11 wherein the second shock absorber end of the shock absorber attaches to a gear housing that houses a set of gears to turn the rear axle.

14. The adjustable youth electric off-road vehicle as in claim 11 wherein the second shock absorber end of the shock absorber attaches to a set of support beams that form at least a portion of the swing arm framework.

15. The adjustable youth electric off-road vehicle as in claim 3 wherein the front lower section of the adjustable youth frame defines a variety of different foot rest heights; and
wherein the adjustable youth frame further comprises:
a set of foot rests, each foot rest of the set of foot rests being constructed and arranged to couple with the front lower section at any of the variety of different foot rest heights to accommodate any of the different youth sizes.

16. The adjustable youth electric off-road vehicle as in claim 15 wherein the set of foot rests includes a left foot rest and a right foot rest; and
wherein the front lower section of the adjustable youth frame further includes:
a plurality of left foot rest support members that extend from the lower support to couple with the left foot rest, and
a plurality of right foot rest support members that extend from the lower support to couple with the right foot rest.

17. The adjustable youth electric off-road vehicle as in claim 16 wherein the left foot rest couples with three left foot rest support members;
wherein the right foot rest couples with three right foot rest support members; and
wherein the battery assembly is supported by the lower support between the three left foot rest support members and the three right foot rest support members.

18. The adjustable youth electric off-road vehicle as in claim 15 wherein the adjustable youth frame further includes:
a modular handlebar coupled with the front lower section, the modular handlebar providing a variety of different handlebar heights; and
an adjustable swing arm assembly coupled with the upper rear sub-frame to support a rear axle at a variety of different predefined angular displacements relative to the lower support of the front lower sub-frame; and
wherein the variety of different handlebar heights, the variety of different foot rest heights, and the variety of different predefined angular displacements operating to provide the variety of different youth sizes.

19. The adjustable youth electric off-road vehicle as in claim 18 wherein the electric propulsion system includes an electric motor that provides drive to the rear axle in response to the electric power; and
wherein the electric motor is coupled with and supported by the adjustable swing arm assembly of the adjustable youth frame.

20. The adjustable youth electric off-road vehicle as in claim 19 wherein the electric propulsion system further includes an electric motor controller constructed and arranged to control the electric motor; and
wherein the electric motor controller is coupled with and supported by the adjustable swing arm assembly of the adjustable youth frame.
